(19) United States
(12) Patent Application Publication
(10) Pub. No.: US 2015/0204822 A1
(43) Pub. Date: Jul. 23, 2015

(54) PHOTOACOUSTIC METROLOGY TOOL

(71) Applicant: Sonex Metrology Ltd., Dublin (IE)

(72) Inventors: Kenneth Horan, Dublin (IE); Michael Cunningham, Co. Kildare (IE); James Fryar, Dublin (IE); David Allen, Co. Carlow (IE); Patrick McNally, Dublin (IE); Kabir Mamum, Dublin (IE)

(21) Appl. No.: 14/413,093

(22) PCT Filed: Jul. 4, 2013
(86) PCT No.: PCT/EP2013/064201

§ 371 Date: Jan. 6, 2015

(30) Foreign Application Priority Data
Jul. 6, 2012 (GB) 1212016.8

(51) Int. Cl. G01N 29/24; G01N 29/04

(52) U.S. Cl. CPC G01N 29/2418; G01N 29/04; G01N 2291/0289; G01N 2291/023; G01N 2291/106

(57) ABSTRACT

A photoacoustic metrology tool comprises at least one light source for optically exciting a unit under test (UUT). A volume is provided for capturing acoustic energy emanating from the UUT as result of optical excitation thereof. An acoustic pick-up is provided for receiving the captured acoustic energy and generating a corresponding electrical signal. A control means is co-operable with the light source and the acoustic pickup for controlling photoacoustic analysis of the UUT.

### FIELD OF THE INVENTION

The present invention relates to a photoacoustic metrology tool. In particular the invention relates to a metrology tool which utilises sound energy resultant from light excitation of a unit under test to perform structural characterisation thereof.

### BACKGROUND

Failure analysis is the process of collecting and analysing data to determine the cause of a failure within materials, structures, devices and circuits fabricated thereon. Such analysis provides vital information when developing new products and improving existing products. Typically, this type of analysis relies on collecting failed components for subsequent examination of the cause of failure using various methods, such as microscopy and spectroscopy. The disadvantage of this approach is that the analysis is not carried out in real time during the manufacturing process which may result in a large number of faulty devices being manufactured before detection. This is undesirable.

There is therefore a need for a photoacoustic metrology tool which addresses at least some of the drawbacks of the prior art.

### SUMMARY

These and other problems are addressed by provision of a photoacoustic metrology tool which utilises sound energy resultant from light excitation of a unit under test to perform structural characterisation thereof.

Accordingly, a first embodiment provides a photoacoustic metrology tool as detailed in claim 1. The teaching also relates to a photoacoustic sensor head as detailed in claim 109. Advantageous embodiments are provided in the dependent claims.

These and other features will be better understood with reference to the followings Figures which are provided to assist in an understanding of the present teaching.

### BRIEF DESCRIPTION OF THE DRAWINGS

The present teaching will now be described with reference to the accompanying drawings in which:

FIG. 1 is a perspective view of a photoacoustic inspection device.

FIG. 2 is another perspective view of the photoacoustic device of FIG. 1.

FIG. 3 is a plan view of a detail of the photoacoustic inspection device of FIG. 1.

FIG. 4 is a diagrammatic illustration of another photoacoustic inspection device.

FIG. 5 is a plan view of the photoacoustic inspection device of FIG. 4.

FIG. 6 is a perspective view of the photoacoustic inspection device of FIG. 4.

FIG. 7 is a rear view of the photoacoustic inspection device of FIG. 4.

FIG. 8 is a cross sectional view of the photoacoustic inspection device along the line AA.

FIG. 9 is a diagrammatic view of another photoacoustic inspection device.

FIG. 10 is a diagrammatic view of the photoacoustic inspection device.

FIG. 11 is a perspective view of another photoacoustic inspection device.

FIG. 12 is a perspective view of another photoacoustic inspection device.

FIG. 13 is a diagrammatic view of a detail of a photoacoustic inspection device.

FIG. 14 is a block diagram of a circuit of a photoacoustic metrology tool in accordance with the present teaching.

FIG. 15 is a block diagram of a production line which includes the photoacoustic metrology tool of the present teaching.

FIG. 16 is a graphical representation of a photoacoustic scan carried out by the photoacoustic metrology tool of the present teaching.

FIG. 17 is a graphical representation of a photoacoustic scan carried out by the photoacoustic metrology tool of the present teaching.

FIG. 18 is a graphical representation of a photoacoustic scan carried out by the photoacoustic metrology tool of the present teaching.

FIG. 19 is an exemplary test set up for implementing photoacoustic analysis of a unit under test.

FIG. 20 is a graph of amplitude versus frequency generated using the test set up of FIG. 19.

FIG. 21 is a plan view of a wafer having a pattern of target sites highlighted.

FIG. 22 is a plan view of a wafer having a pattern of target sites highlighted.

FIG. 23A is a plan view of a wafer having a pattern of target sites highlighted.

FIG. 23B is a plan view of a wafer having a pattern of target sites highlighted.

FIG. 24 is a diagrammatic illustration of an exemplary sensor head in accordance with the present teaching.

FIG. 25 is a diagrammatic illustration of an exemplary sensor head in accordance with the present teaching.

FIG. 26 is a plan view of a wafer under test.

FIG. 27 is a graphical representation of a photoacoustic scan carried out by the photoacoustic metrology tool of the present teaching.

FIG. 28 is a graphical representation of a photoacoustic scan carried out by the photoacoustic metrology tool of the present teaching.

FIG. 29 is a diagrammatic illustration of defects in a packaged semiconductor chip which may be detected using the metrology tool of the present teaching.

FIG. 30A is a cross sectional plan view of a packaged semiconductor chip.

FIG. 30B is a cross sectional plan view of a packaged semiconductor chip.

FIG. 31A is a plan view of a semiconductor wafer under test.

FIG. 31B is a graphical representation of a photoacoustic scan of the semiconductor wafer of FIG. 31A carried by the photoacoustic metrology tool of the present teaching.

FIG. 32 is a perspective view a sensor head also in accordance with the present teaching.

FIG. 33 is another perspective view of the sensor head of FIG. 32.

FIG. 34 is an exploded view of the sensor head of FIG. 32.

FIG. 35 is another exploded view of the sensor head of FIG. 32.

FIG. 36 is a further exploded view of the sensor head of FIG. 32.

FIG. 37 is an exploded side cross sectional view of the sensor head of FIG. 36.

FIG. 38 is a cross sectional side view of the sensor head of FIG. 32.

FIG. 39 is an exemplary photoacoustic inspection cell.

FIG. 40 is an exemplary photoacoustic inspection cell.

FIG. 41 is a plan view of an exemplary photoacoustic inspection cell.

FIG. 42 is a plan view of an exemplary photoacoustic inspection cell.

FIG. 43 is an exemplary photoacoustic inspection test set-up.

FIG. 44 is an exemplary photoacoustic inspection test set-up.

FIG. 45 is an example of a dataset reconstructed from the raw microphone signals.

FIG. 46 is a cross section of an exemplary multi-layered sample under test.

FIG. 47 is a graphical representation of the depth of the reflecting interfaces.

FIG. 48 is a graphical representation of a detected void.

FIG. 49 is a graphical representation of a through silicon void structure.

FIG. 50 is an exemplary process flow which is also in accordance with the present teaching.

FIG. 51 is an exemplary alignment mechanism.

FIG. 52 is an exemplary alignment mechanism.

FIG. 53 is a block diagram of an exemplary photoacoustic metrology tool.

### DETAILED DESCRIPTION OF THE DRAWINGS

The application will now be described with reference to some exemplary photoacoustic inspection metrology tools which are provided to assist in an understanding of the present teaching. It will be appreciated that for simplicity and clarity of illustration, where considered appropriate, reference numerals may be repeated among the figures to indicate corresponding or analogous elements.

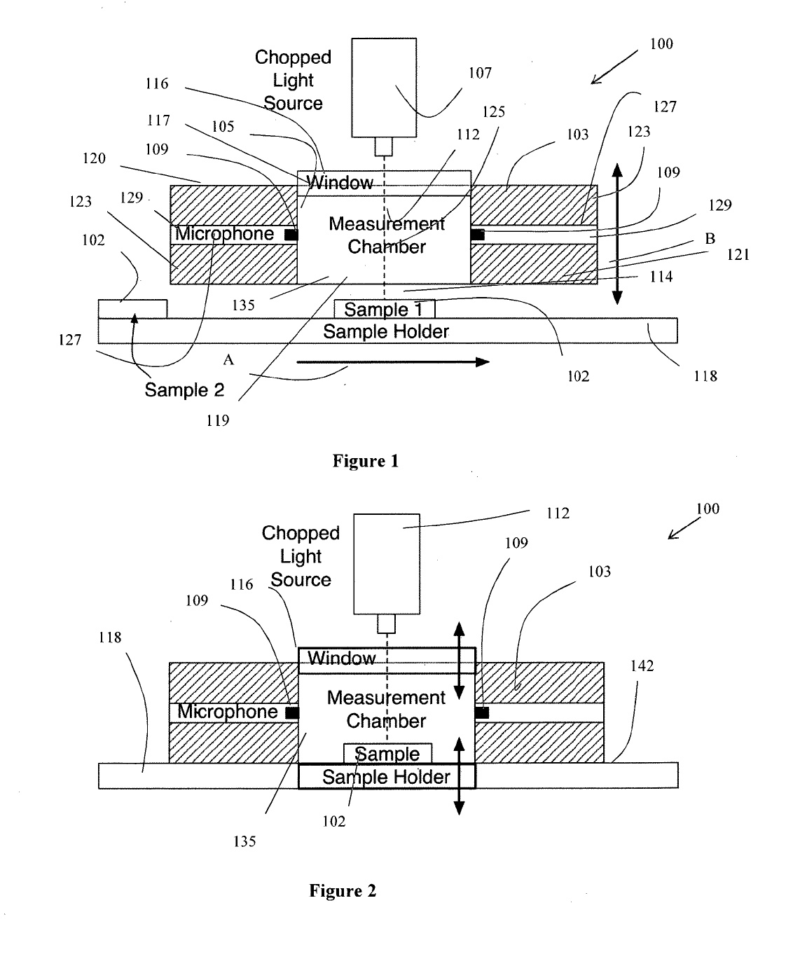

Referring to the drawings and initially to FIGS. 1 to 3 there is provided a photoacoustic inspection device 100 which utilises sound energy resultant from light excitation of a unit under test (UUT) 102 to perform structural characterisation thereof. The device 100 comprises a test member 103 which defines a trap volume 105 for capturing acoustic energy emanating from the UUT 102, in this case, an integrated circuit chip. An optical excitation input 107 is in optical communication with the UUT 102 for exciting the UUT 102. The UUT 102 is in acoustic communication with the trap volume 105 such that acoustic energy emanating from the UUT 102 as result of optical excitation enters the trap volume 105. In the exemplary arrangement, the optical excitation input 107 is in registration with the trap volume 105. One or more acoustic pickups 109 are provided on the test member 103 and are in acoustic communication with the trap volume 105 for picking up acoustic energy resultant from excitation of the UUT 102. Acoustic pick-ups 109 are transducers configured for converting mechanical vibrations resulting from acoustic energy into electrical energy. While the exemplary teaching will be described with reference to the UUT being semiconductor chips, it will be appreciated that a photoacoustic inspection device 100 in accordance with the present teaching may be used with a variety of different UUTs types and dimensions—and indeed whole or part of individual UUTs. For example, the UUT may be a whole or partial substrate and may be carried on a carrier member if desired. It is not intended to limit the UUT to any particular shape or size. It is envisaged that the UUTS could include for example, electronic products such as printed circuit boards (PCBs), LCDs, transistors, automotive parts, aeroplane parts, lids and labels on product packages, agricultural vegetation (seed corn, fruits, vegetables, or the like), and medical devices such as stents or the like.

The trap volume 105 extends between a first location 117 and a second location 119 on the test member 103. A transparent window 116 closes the trap volume adjacent the first location 117 and an access opening/entry port 135 is provided on the test member 103 adjacent the second location 119. It will be appreciated that the trap volume 105 is a hollow region formed on the test member, thus the test member 103 provides a container which contains acoustic energy therein. The container is closed except at an entry port where an opening is provided leading to the trap volume which allows acoustic energy emanating from the UUT 102 to enter the trap volume. Acoustic channels 127 are formed intermediate the first and second locations 117, 119 which accommodate the acoustic pickups 109 therein, in the exemplary embodiment, the acoustic pick-up are provided by microphones. The optical excitation input 107 provides a light source 112 which may be a laser or a broad spectrum light source. The light source is focused and/or scanned across the UUT 102 on an upper major surface 114 thereof. Light from the light source 112 enters the trap volume 105 through a transparent window 116 and is intensity-modulated at a predetermined frequency. The UUT 102 moves in a controlled manner relative to the light source 112, desirably on a support member 118 of a conveyor. In the exemplary embodiment the support member 118 moves in a direction indicated by arrow A. The test member 103 may be axially moveable relative to the support member 118 as indicated by arrow B in FIG. 1. Some light is absorbed by the UUT 102 on or close to the surface 114 causing periodic surface heating to occur at the modulation frequency. The periodic surface heating in the UUT 102 provides a source of thermal waves that propagate from the UUT 102. This periodic heating causes a periodic pressure variation which is picked up by the acoustic pick up 109. As the modulation frequency is related to the thermal diffusion length of the material of the UUT 102, various depths within the UUT 102 can be probed. A test measurement may be obtained by varying the position on the UUT 102 and/or the frequency at which the light is chopped. Alternatively, a test measurement may be obtained by determining the acoustic signal of the UUT 102 as a function of the wavelength of the incident light source 112. A graphical representation of the photoacoustic amplitude and/or phase may be generated for displaying on a graphical user interface.

The test member 103 comprises an upper major surface 120 and a lower major surface 121 with spaced part ends 123 extending there between. While the optical excitation input 107 is illustrated as being located above the upper major surface 120 pointing downwards it may also be located beneath the lower major surface 121 pointing upwards. The trap volume 105 has an axis of formation 125. Acoustic channels 127 extend radially from the trap volume 105 to pick-up ports 129 through which microphones are loaded to the acoustic channels 127. In the exemplary embodiment, the microphones together with the acoustic channels 127 form the acoustic pick-ups 109. It will be appreciated by those skilled in the art that the acoustic channels 127 are in acoustic communication with the trap volume 105. A formation 131 is formed on the lower major surface 121 of the test member 103, see FIG. 3, and is configured to receive a sealing member for facilitating acoustic sealing the opening 135 of the entry port leading to the trap volume 105 when the lower major surface 121 of the test member 103 operably engages the support 118 or is in close proximity to the UUT. An annular edge extends around the access opening 135 and defines a rim which in operation is located adjacent the UUT 102. In this way it will be appreciated by those skilled in the art that in one embodiment the rim of the entry port abuts the support 118 on which the UUT 102 is supported.

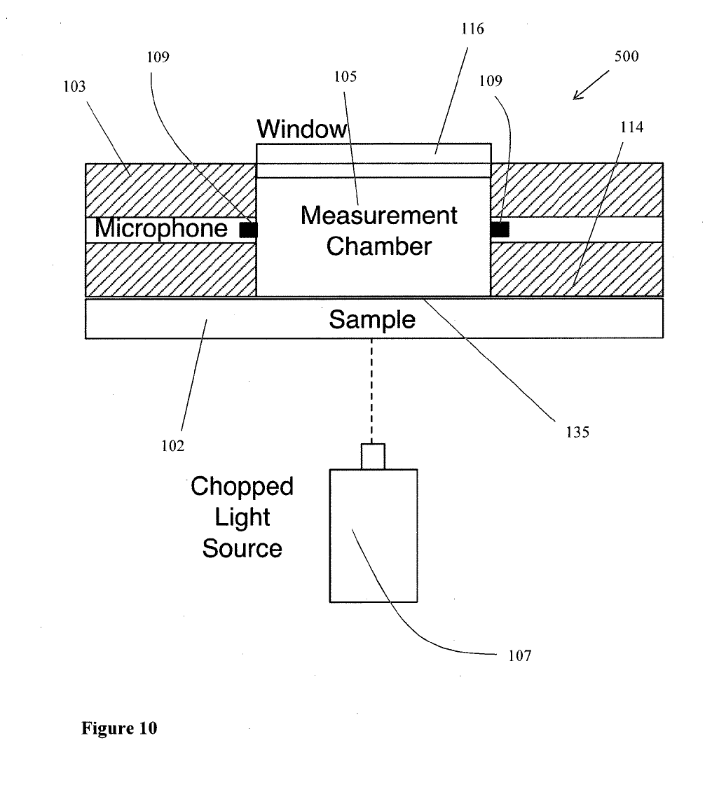

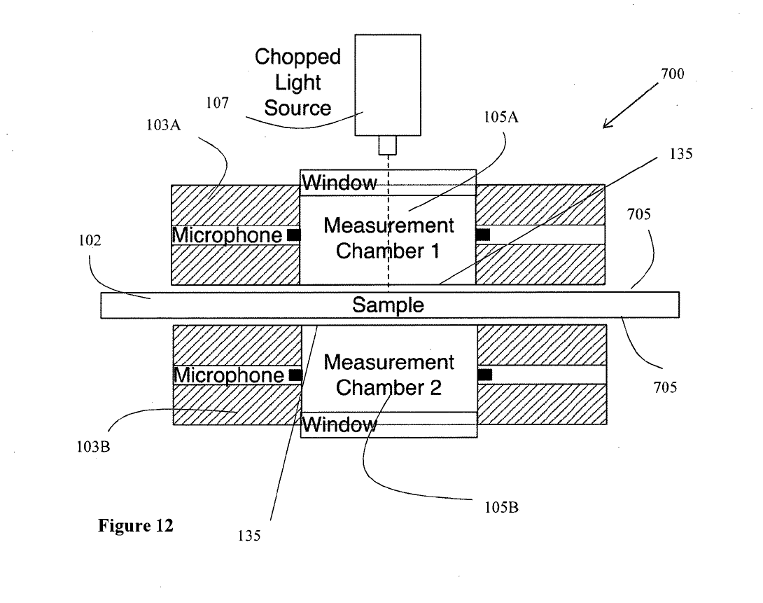

Alternatively, the rim of the entry port is located in close proximity to a UUT which has a large surface area for creating a proximity acoustic baffle, the proximity acoustic baffle arrangement is best illustrated in FIGS. 10 and 12. The proximity acoustic baffle arrangement is particularly advantageous for testing large wafers (UUTS) that are too large to fit in the trap volume 105. In the proximity acoustic baffle arrangement the second location 119 of the test member 103 is located next to the UUT 102, in some cases, not touching. The UUT 102 may contain sensitive circuitry fabricated thereon and it would therefore be undesirable to directly contact the UUT with the test member 103 as intimate contact could damage the sensitive circuitry. If the UUT 102 is robust the test member 103 in operation may operably engage the UUT 102 such that the bottom surface 121 of the test member abuts the UUT either directly or via a sealing gasket. In such a scenario the trap volume 105 will be closed or at least partially closed. It will therefore be appreciated by those skilled in the art that in the operative position the rim of the access opening 135 is located adjacent the UUT 102. Thus the term adjacent is intended to cover test setups when the rim is in direct contact with the UUT 102 or in close proximity thereto. It will be appreciated that when the rim of the access opening 135 is provided adjacent the UUT 102 an acoustic proximity baffle is formed which traps the acoustic energy in the trap volume 105. The proximity acoustic baffle prevents or limits the escape of acoustic energy from the trap volume 105.

During testing the support member 118 may be stationary or moving and the test member 103 may be operated to adjust its position accordingly. In one embodiment, the test member 103 moves in tandem with the support member 118. In the exemplary embodiment, a train of UUTs 102 are provided on the support member 118 of a moving conveyor and the test member 103 hovers between the individual UUTs 102 so that the UUTs may be discretely tested on the conveyor. In one embodiment, the rim of the access opening 135 abuts the support member 118 for creating an acoustic baffle around the respective UUT 102. It will therefore be appreciated that acoustic energy emanating from the UUT as result of optical excitation enters the trap volume via the access opening 135. Thus the support member 118 provides a surface on which the UUT 102 is supported. In the exemplary embodiment the sealing member is provided as a closed loop elastic rubber band, preferably, an O-Ring which acts as a sealing gasket between the mating surfaces of the test member 121 and supporting member 118. In the exemplary arrangement, the closed loop elastic band surrounds an annular protrusion 138 and is seated in a recess 140 formed on the lower major surface 121 of the test member 103. When the rim of the access opening 135 operably engages with the supporting member 118 the access opening 135 is closed by the upper major surface of the supporting member 142. In this scenario, the trap volume 105 defines a closed volume with one end of the trap volume being closed by the transparent window 116 and the opposite end of the trap volume being closed by the supporting member 118 on which the UUT 102 is carried. Thus the trap volume 105 defines an elongated blind channel with one end open.

A carrier mechanism 144, best illustrated in FIG. 6, is operably coupled to coupling means on the test member 103 and is configured for moving the test member relative to the conveyor 118. The UUT 102 is moved relative to the test member on the support member 118. It will therefore be appreciated that the supporting member may be operable to move with respect to X, Y and Z planes as desired. Alternatively, the carrier member 144 may be operable to move the test member 103 relative to the UUT 102. The carrier member may be configured to move the test member 103 with respect to X, Y and Z planes as desired.

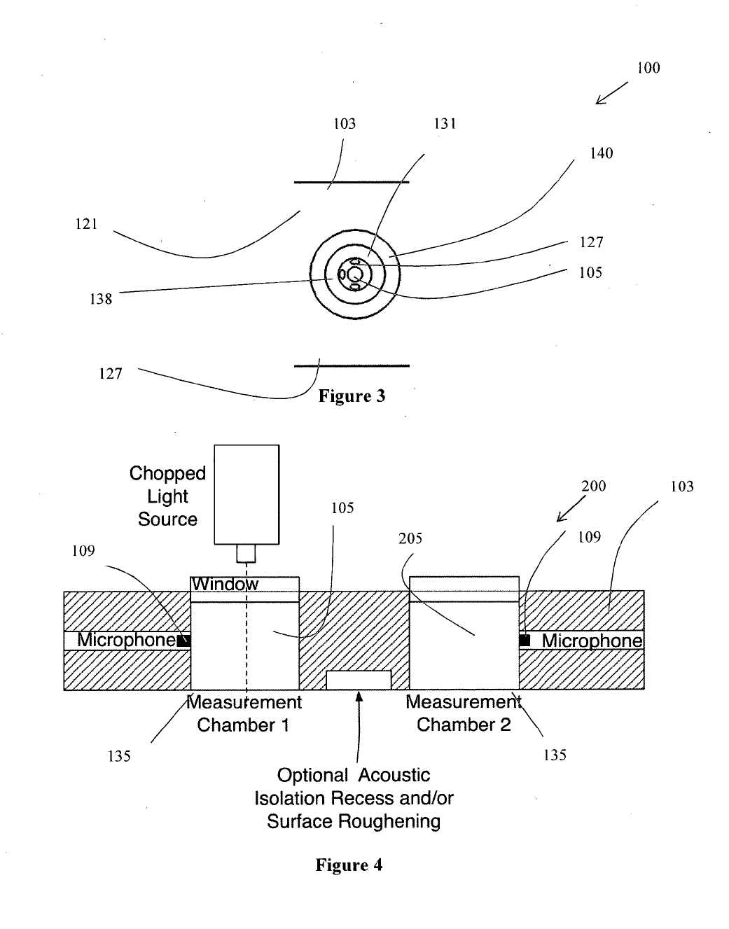

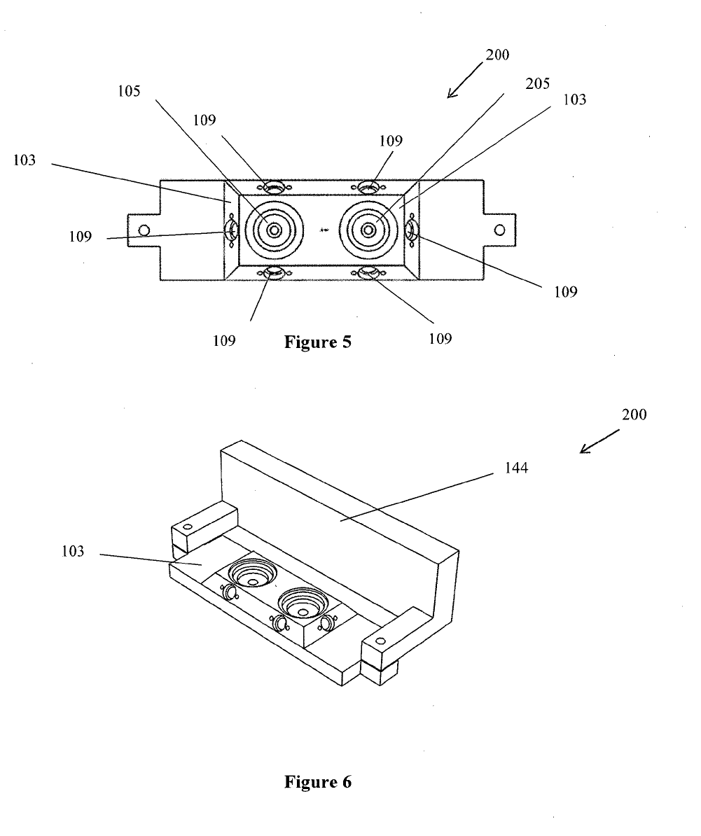

Referring now to FIGS. 4 to 7 there is illustrated another photoacoustic inspection device 200. The device 200 is substantially similar to the device 100 and similar features are indicated by the same reference numerals. The device 200 includes a control channel 205 which provides a control test chamber. The control channel 205 facilitates differential analysis. By providing a control volume, the test member may be used in a differential mode test setup. In a differential mode test setup, the trap volume 105 is illuminated with the light source 112. The acoustic signal from the trap volume 105 which is picked up by the acoustic pick-ups 109 is a combination of the ambient noise and a photoacoustic signal. At the same time, the acoustics within the control channel 205 is also recorded. However, as the control channel 205 has no optical excitation input its signal represents ambient background noise. By subtracting the acoustic signal of the control channel 205 from the acoustic signal of trap volume 105 substantially eliminates the ambient noise and thereby isolates the photoacoustic signal of the trap volume 105. The differential analysis may be enhanced by providing an acoustic baffle between the trap volume 105 and the control volume 205 which limits the transfer of acoustic energy from the illuminated trap volume 105 to the dark control volume 205. In an alternative arrangement the control volume 205 may incorporate a laser. In this case, the control volume 205 generates a known signal using a known good sample with a substantially identical structure to that of the UUT or a reference sample.

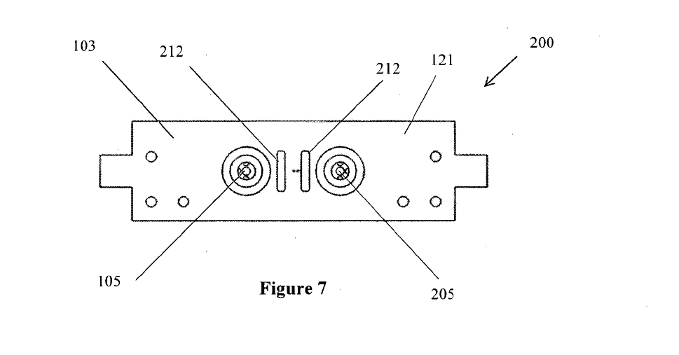

In the exemplary arrangement the acoustic baffle is provided by a pair of elongated trenches 212 formed on the lower major surface 121 of the test member 103, as best illustrated in FIG. 7. The recess 140 in which the 0-Ring is seated also acts as an acoustic baffle. A further acoustic baffle is provided on the test member 103 between the trap volume 105 and the second volume 205. In the exemplary arrangement, the acoustic baffle includes one or more trenches 212 formed on a surface of the test member 103. Ideally, the trenches 212 are in a parallel configuration but alternative configurations are envisaged.

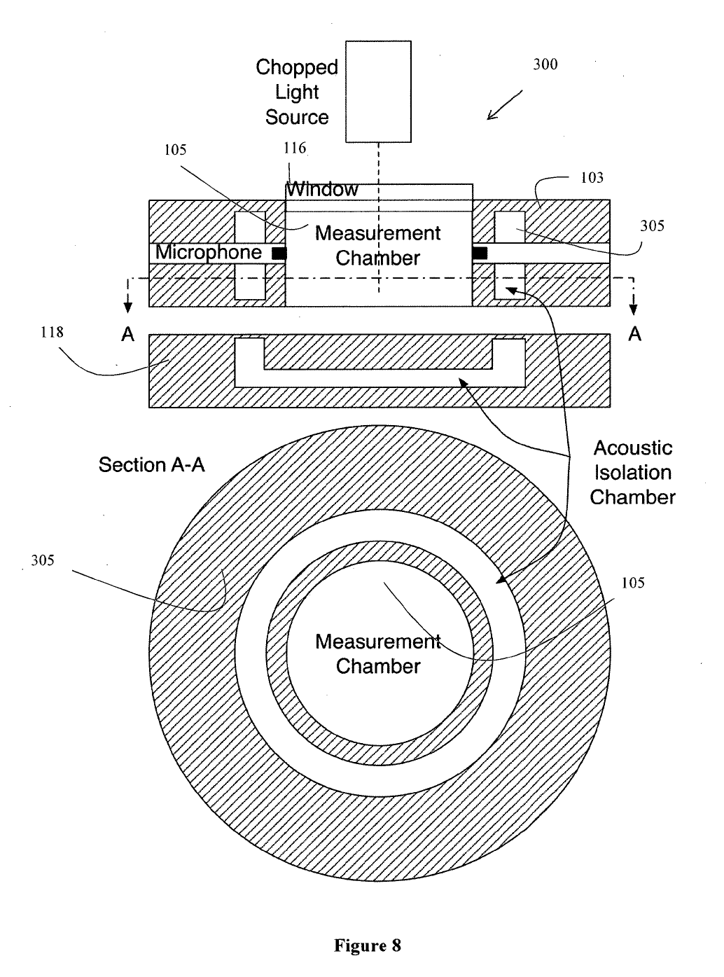

Referring now to FIG. 8 there is illustrated another photoacoustic inspection device 300. The device 300 is substantially similar to the device 100 and similar features are indicated by the same reference numerals. The trap volume 105 in the device 300 is surrounded by an outer chamber 305 which may be filled with a sound suppressing material e.g. liquid, gas, gel, particulate solid or may simply be evacuated. The sound suppressing material contains the acoustic energy in the trap volume 105. The outer chamber 305 may be provided on the UUT 102 supporting member if desired. The transparent window 116 may be provided in a multi-glazing formation. In the exemplary arrangement, the transparent window 116 is provided in a double glazing formation with an evacuated volume located between two panes of glass. The multi pane arrangement inhibits the transfer of sound through the window 116.

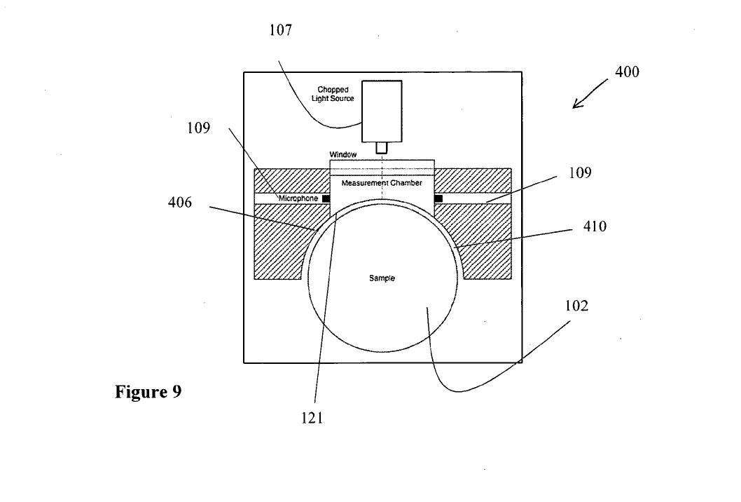

Referring now to FIG. 9 there is illustrated another photoacoustic inspection device 400. The device 400 is substantially similar to the device 100 and similar features are indicated by like reference numerals. The device 400 is suited for receiving UUTs 102 in its trap volume 105 which are not flat. The side walls 406 define an arched or dome portion 410 for accommodating UUTs which have an arcuate or protruding surface. Thus the trap volume is of a complimentary shape to that of the UUT. The lower major surface 121 of the test member 103 conforms in shape to that of the surface of the sample under test. In the exemplary arrangement, the surface 121 defines an arch/hemisphere for receiving a spherical UUT 102 or similar shape.

Referring now to FIG. 10 there is illustrated another photoacoustic inspection device 500. The device 500 is substantially similar to the device 100 and similar features are indicated by like reference numerals. In this embodiment the UUT 102 has a surface area which is larger than the width of the trap volume 105. The test member 103 in operation is brought into close proximity to the upper surface of the UUT 102 and a proximity acoustic seal is created between the bottom major surface 121 of the test member 103 and the upper major surface of the UUT 102. In this example, the UUT is a large wafer, however, alternative sample types are envisaged. The test member 103 does not make contact with the UUT 102 but an acoustic seal is created based on the close proximity of the UUT 2 and test member 103. In this arrangement the optical input 107 is located below both the test member 103 and the UUT 102. It will therefore be appreciated that it is not necessary for the trap volume 105 to be illuminated as the UUT 102 occludes the access opening 135 to the trap volume 105 preventing light entering. However, acoustic energy as result of the optical excitation of the UUT 102 is contained/restrained in the trap volume 105 as a result of the proximity acoustic seal. In this exemplary arrangement, a proximity acoustic baffle is provided by locating the access opening 135 to the trap volume 105 in close proximity to the upper major surface of the UUT 102. Depending on the characteristics of the UUT 102 some light from the light source may penetrate the UUT 102 and enter the trap volume 105 and exit the trap volume 105 via the window 116. In certain scenarios, it may be advantageous to capture the light exciting the window 116 to determine the wavelengths absorbed by the UUT, for example. Thus the test set up is particularly suitable for simultaneously carrying out acoustic and optical analysis on the UUT and also avoids correlated photoacoustic signals originating on the trap volume wall and/or microphone.

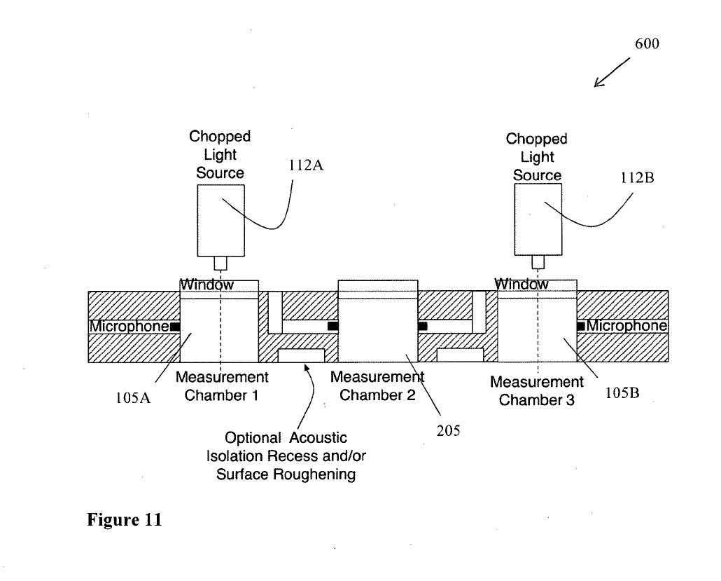

Referring now to FIG. 11 there is illustrated another photoacoustic inspection device 600. The device 600 is substantially similar to the device 100 and similar features are indicated by like reference numerals. In this exemplary arrangement, two trap volumes 105A, 105B are provided and one control volume 205. The control volume 205 may be used to calibrate trap volumes 105A and 105B by capturing the ambient noise signal which may then be subtracted from the acoustic signal captured in the respective trap volume 105A and 105B. It will be appreciated that by providing two trap volumes facilitates the testing of two UUTs simultaneously thereby increasing testing throughput. It will also be appreciated that for a large UUT the two trap volumes can capture acoustic energy emanating from a single UUT at two separate locations. Thus two different locations or two measurements of the same location taken at two different times on the single UUT may be analysed. The two acoustic signals captured in the respective trap volumes may be averaged thereby increasing the signal-to-noise ratio. Two light sources are provided 112A and 1128 which may be operated at the same or different frequencies. In certain scenarios it may be desirable to operate light sources 112A and 1128 at two different wavelengths, for example, by operating light source 112A above the UUT's band gap and light source 1128 below the UUT's band gap. Alternatively, to increase the signal to noise ratio both light sources 112A and 1128 may be operated at the same wavelength. In the exemplary arrangement only two trap volumes 105 and one control volume 205 are described, however, it is envisaged that any desired number of trap volumes 105 and control volumes 205 may be provided.

Referring now to FIG. 12 there is illustrated another photoacoustic inspection device 700. The device 700 is substantially similar to the device 100 and similar features are indicated by like reference numerals. The device 700 includes two test members 103A and 103B which are stacked vertically in order to capture acoustic energy emanating from the respective opposite major surfaces 705 of the UUT 102. The UUT 102 is located intermediate the test member 103A and 103B. In this arrangement, a proximity acoustic baffle is provided by locating the access opening 135 to the trap volumes 105A and 105B in close proximity to the respective major surfaces 705 of the UUT 102.

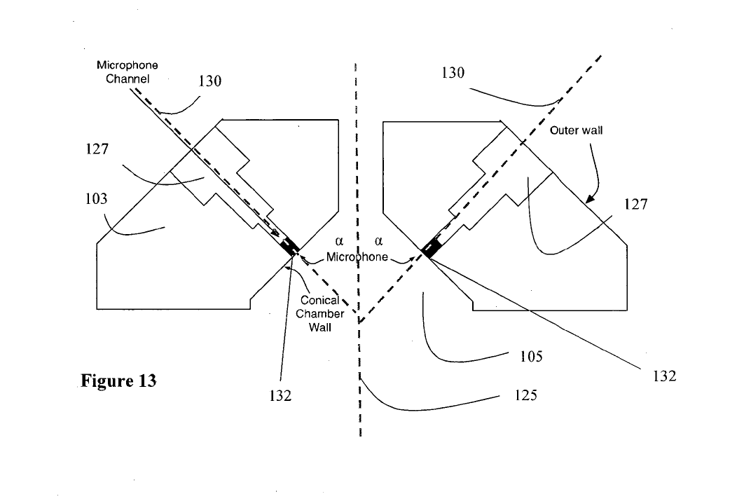

Referring now to FIG. 13 there is provided a diagrammatic illustration of the optimum arrangement of the acoustic channels. The present inventors have realised that by orienting the acoustic channels 127 such that a face 132 of the acoustic pick-up (microphone) is normal to the wave-vector of the pressure wave approaching it maximizes the force exerted by the acoustic energy on a diaphragm of the acoustic pick-up. The diaphragm is a thin member located adjacent the face of acoustic pick-up which vibrates when impacted by sound waves. It will be well known to those skilled in the art that acoustic pick-ups are acoustic to electric sensors that convert sound energy into electrical energy and accordingly it is not intended to describe them further. Thus it is advantageous to orientate the acoustic channels 127 such that their longitudinal axis defines an acute angle α with respect to the axis of formation 125 of the trap volume 105 in order for the face of the diaphragm to receive maximum force from the sound waves emanating from the UUT. In the exemplary arrangement angle α is about 45°. Ideally, the angle α is in the range of 30° to 50°. It will be appreciated that ideally the microphones are pointed at the source of the acoustic energy emanating from the UUT 102. Furthermore, the optimum angle for a depends on the dimensions of the trap volume 105.

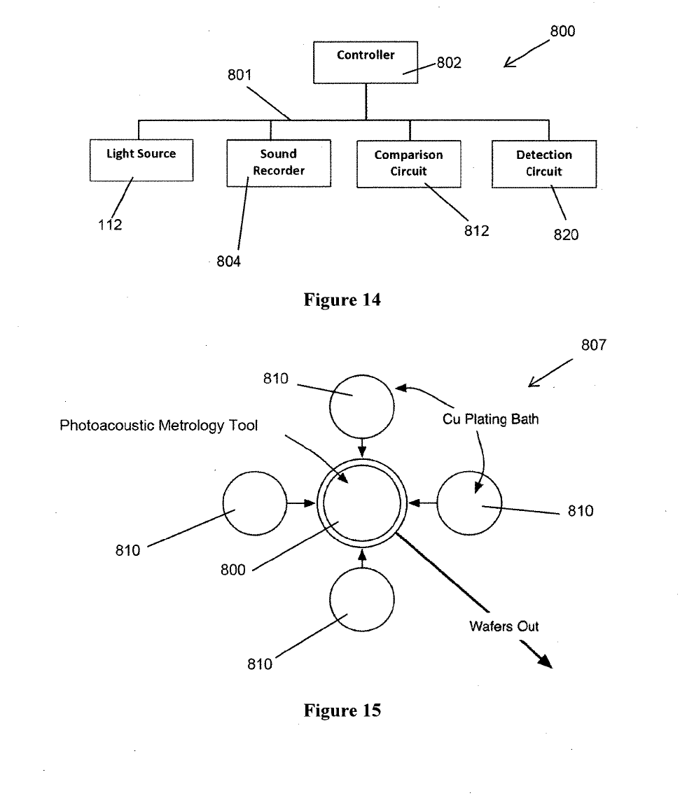

A photoacoustic metrology tool 800 in accordance with the present teaching may include one of more of the photoacoustic inspections devices 100, 200, 300, 400, 500, 600, and 700 as illustrated in FIG. 14. The inspection devices provide measurement cells in a sensor head of the photoacoustic metrology tool 800. The tool 800 comprises a control circuit 801 that controls the photoacoustic analysis of the UUT. In the exemplary arrangement, the control circuit 801 comprises a controller 802 which is in communication with the light source 112 and a sound recorder 804. The sound recorder 800 is operable to record the sound signals generated by the acoustic pickups 109. The photoacoustic metrology tool 800 may be incorporated into a production line process 807 that is used to manufacture the UUT. In the exemplary production line process 807 of FIG. 15, the UUT is a semiconductor wafer and the production line is arranged such that the semiconductor wafer is plated with copper (CU). The production line process 807 includes multiple Cu plating baths 810, each feeding into a centrally located photoacoustic metrology tool 800. The photoacoustic metrology tool 800 is controlled by the control circuit 801 to carry out a set of predefined measurements.

The control circuit 801 may include a comparison circuit 812 which is operable to compare the generated acoustic signals as a result of the light source 112 optically exciting the UUT against a predefined set of criteria. If the comparison circuit 812 passes the wafers they will be transferred to the next processing step of the production line 807. However if the comparison circuit 812 indicates that the wafer fails to meet the predefined set of criteria, the control circuit 801 is operable to flag the failure to an operator who may use this information to shut down the individual CU plating bath 810 from which resulted in the failure or the entire process if appropriate. It will therefore be appreciated, that the photoacoustic metrology tool 800 is operable to perform real-time test measurements in a production line so that batch production may be halted if the tool detects failures as the wafers are being processed. Traditionally, the batch run would be completed before the individual wafers are tested for faults. The disadvantage of this approach is that the analysis is not carried out in real time during the manufacturing process which may result in a large number of faulty wafers being manufactured before detection. It is more economical if faulty wafers are detected in real-time so that the batch process may be stopped during the process. Thus the photoacoustic metrology tool 800 provides a station in the production line for implementing real-time photoacoustic analysis on the UUT as the UUT is being transferred between various stations of the production line 807.

Through-Silicon-Vias (TSVs) provide a means of connecting stacked integrated circuit (IC) die. An issue with the production of stacked IC die is the generation of voids due to their high aspect ratio. The photoacoustic metrology tool 800 is capable of detecting voids in TSVs. Thus the tool 800 may be used to detect voided TSVs in the Cu plating process of FIG. 15 for example. The tool may be integrated into the process flow of the fabrication process and have its own front-end mechatronics for accepting and managing wafer deliver to its sensor head.

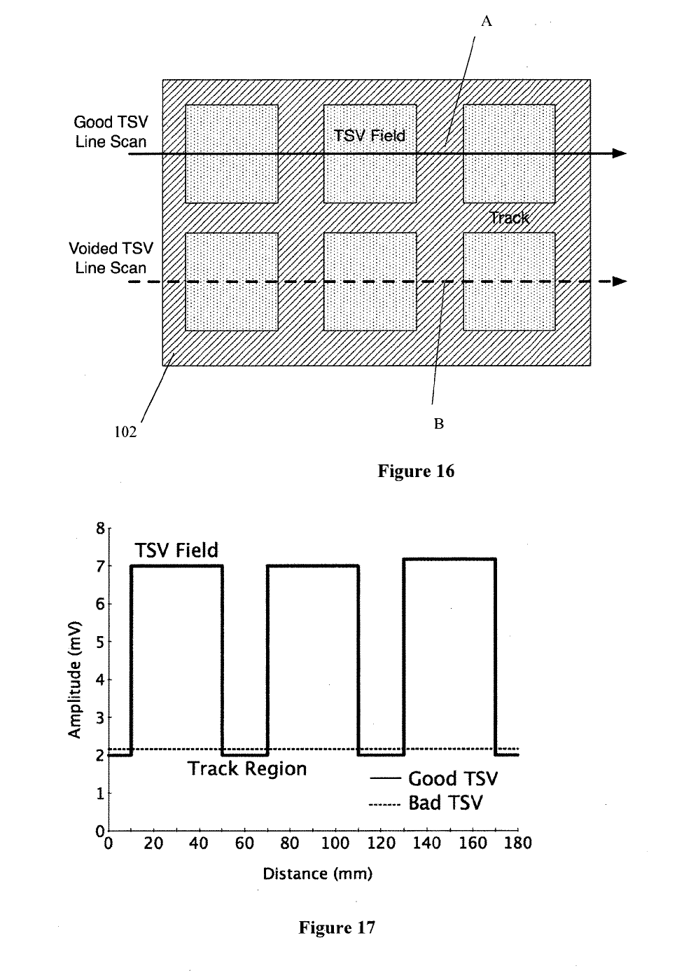

The tool 800 may have a pre-test mode configured for identifying specific regions of interest on the UUT, and a test mode configured for performing photoacoustic analysis at the specific regions of interest identified during the pre-test mode. For example, in the pre-test mode the tool may be operable to read location co-ordinates identifying the specific regions of interest on the UUT. The controller 802 is operable to register the specific regions of interest identified on the UUT with the measurement cells based on the read location co-ordinates. In one example, when the tool is in the pre-test mode a preliminary photoacoustic scan of a portion of the UUT is performed to identify structural characteristics of a scanned portion of the UUT. The measurement scan may be run along a line between two points on the surface of the UUT. For example, the preliminary scan may be run along lines ‘A’ and ‘B’ on the surface of the UUT 102 as illustrated in FIG. 16. One of the key application areas of the present teaching is the detection of voiding in metal layers, such as Through-Silicon Vias (TSVs) on semiconductor wafers. A major failure mechanism in TSV manufacturing are top-voids. As the name suggests, these are voids which are generated at the top of the TSVs during copper (Cu) plating. This failure mechanism is an excursion event and when it occurs it is usually detrimental to the process, effecting all (or a large proportion) of TSVs on the wafer. Due to the extent of the event, a relatively small number of samples are required to detect its occurrence.

Precise alignment of the UUT with respect to the sensor head of the photoacoustic metrology tool 800 may be difficult to achieve and may add significantly to the cost of the fabrication process. The present inventors have realised that by performing a line scan on the UUT 102 alleviate some of the preciseness of the alignment requirements. All that is required is to identify at least one region of interest (TSV field region) and one control region (Track region) within the range of the line scan. In the exemplary arrangement the region of interest is a TSV field region and the control region is a track region. A track region is an area of the sample which does not contain TSVs. Once provided with some apriori information on the layout of the TSV field e.g. width of the field, distance between the fields, a line scan of suitable length and step-size can be devised which will provide sufficient measurements in both track and field regions. Line ‘A’ of FIG. 16 illustrates a line scan crossing good TSV fields while line ‘B’ illustrates a line scan crossing top-voided fields.

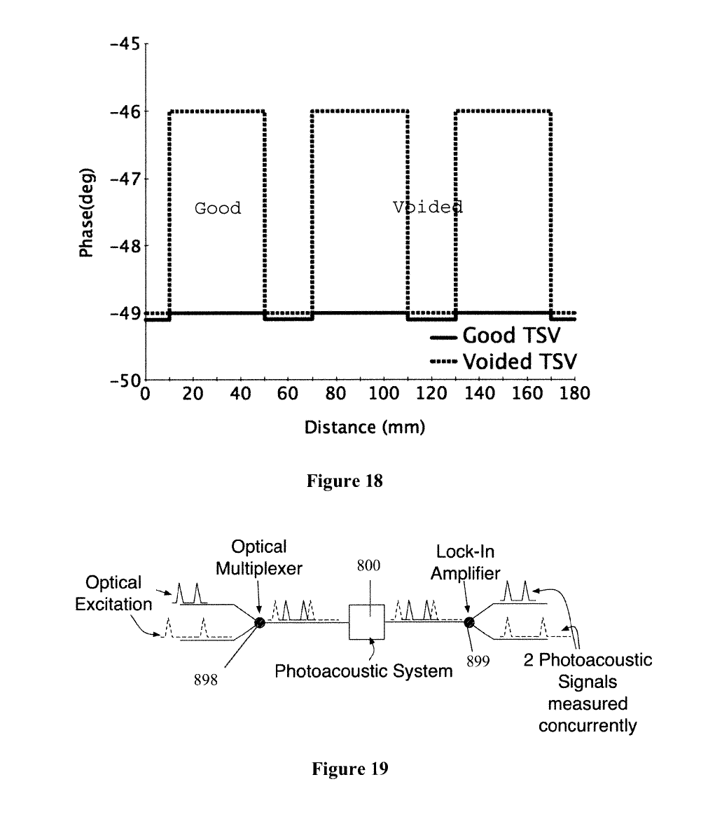

The control circuit 801 may be configured to generate a graphical representation of the line scans on a graphical user interface as illustrated in FIG. 17 which shows a clear variation between the photoacoustic response of the good TSV region and that of the surrounding track region. This variation is suppressed with the introduction of top-voids. Having run a scan similar to that described above, an analysis of the variation in the data can be used to identify the presence or otherwise of top-voids. Point-to-point variability within the TSV field is also suppressed in the presence of top-voids which reinforces the above analysis methodology. In addition to amplitude sensitivity, phase data may also be used to identify top-voided TSVs. FIG. 18 shows the phase data related to the line scans ‘A’ and ‘B’. Although the contrast between good and bad TSVs is not as clear in phase, the signal associated with the presence of voids is isolated, i.e. detection of a phase signal in a certain range (TBD) would indicate the presence of TSV top-voids, whereas all other signals indicate either track regions or clear TSVs. A second advantage to using the phase data to test for voided TSVs is the frequency dependence of the response.

Phase data is a measure of the time delay between the light pulse and the acoustic response. In instances of boundary layer detection (voiding), it is common for there to be a delay at the boundary as heat must accumulate at the interface before returning to the surface. In operation, a measurement cell is aligned to a first position on the UUT and the UUT remains in a rest state at this position. The light source 112 applies modulated light which incidents on the UUT. The microphones (acoustic pick-ups) record the resulting photoacoustic signal. Signals are amplified by electronics and the component at the chopping frequency is extracted through a lock-in amplifier. The amplitude and phase of the signal is output to a computer on which it is recorded. The UUT is then moved to a second position and the above steps are repeated. This process is repeated through to the final point. The data can then be further analysed to provide a pass/fail response.

The photoacoustic data from voids in metals generally has a distinct frequency response. Due to the delay at the interface during heat accumulation, the phase response from a void increases with decreasing frequency (more rapidly than in the absence of the void). This feature of the response can be used to identify voided TSVs through one of the following methods:

1. frequency scans; and

2. multiplexed signals.

The frequency scan approach is the more straight forward of the methods but is also time consuming. The multiplexed signals approach applies multiple signal frequencies into the measurement cell and multiple frequency responses are concurrently detected. Two key parameters of a photoacoustic experiment are controlled by the optical excitation; the optical penetration depth and the thermal diffusion length of the produced thermal waves. These are controlled by the wavelength and chopping frequency of the light source 112 respectively. By varying these parameters, different information can be extracted from the UUT 102. Certain failure mechanisms respond predictably to changes in parameters e.g. the signal phase-shift in the presence of a void generally reduces with increasing frequency. By analysing these responses, additional confidence can be applied to the resulting assertions. The mechanisms of variation depend on the measurement time and the system complexity. A method of reliably extracting the separate signals is necessary however.

One method of varying a parameter is through serial measurements. In the case of chopping frequency, this involves performing a measurement at a first frequency, then tuning the system to a second frequency and repeating the measurement and so on. A possible set-up for a wavelength variation would be through multiplexing two different wavelength lasers into a single fibre and alternating between the two. A second method for analysing the response to wavelength variation would be to spatially separate two measurement points, one fed from a laser of the first wavelength the other fed by laser of the second wavelength.

In terms of speed, a parallel measurement approach is advantageous. The approach requires firstly combining the incoming signals prior to measurement and secondly separating the photoacoustic responses post measurement as illustrated in FIG. 19. An optical multiplexer 898 is provided for combining the incoming optical excitations signals which emanate from the light source. In the exemplary case two or more different wavelengths are combined together to form a single signal. The left hand side of FIG. 19 shows the multiplexing/coupling of two signals of different frequency (and possibly wavelength) prior to the photoacoustic metrology tool 800 performing a photoacoustic measurement. The sound recorded in a photoacoustic measurement preceded by such a signal mixing process will contain signals at each of the chopping frequencies and noise. Information solely related to a change in wavelength will be inseparable from other signals at a similar chopping frequency. Therefore in order to extract the information related to wavelength variations, the chopping frequency of each input signal may be altered slightly relative to other input signals. Once this has been taken into account the signals can be easily extracted using a lock-in amplifier 899 or similar circuit element.

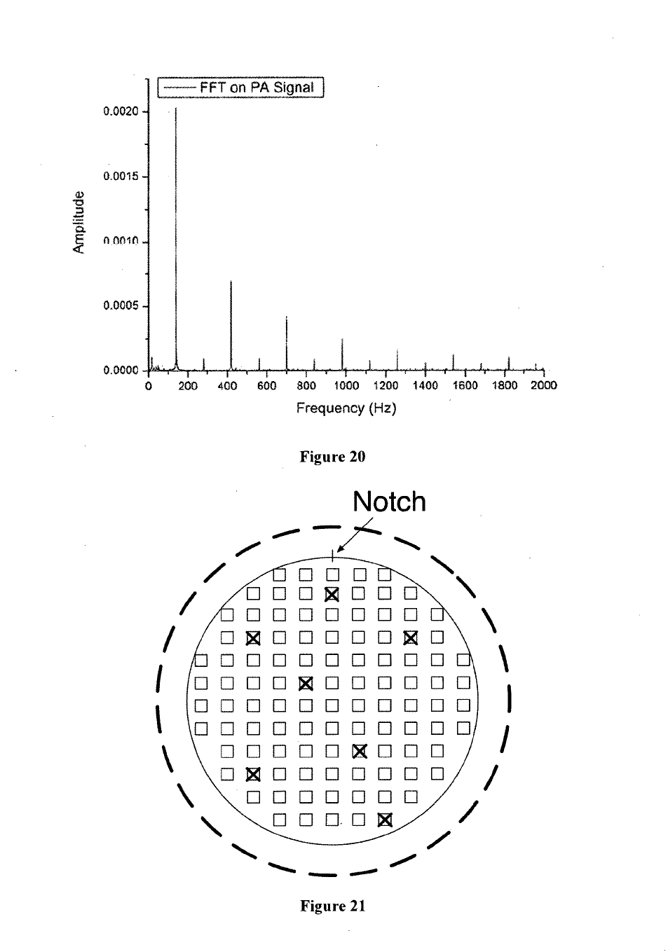

An alternate method combines the measurement time gains associated with parallel measurements and the simplicity of a serial methodology, this is based on the analysis of harmonics. Under this methodology the excitation side of the experiment remains as it would be for a traditional photoacoustic measurement. The data analysis however, instead of relying on a hardware lock-in amplifier, digitises the signals from the microphones (possibly amplified) in an analogue to digital converter (ADC). This allows digital manipulation of the signals including Fourier analysis. FIG. 20 shows the Fourier transform of a 140 Hz photoacoustic signal. As can be seen, in addition to the 140 Hz excitation, signals have been excited at its harmonics, most strongly at the odd harmonics. Analysis of these additional signals allows parallel analysis of frequency trends without additional hardware or complexity on the excitation side of the experimental setup. These particular peaks arise through the use of a TTL square wave excitation. By reducing the duration of the laser pulses, a delta pulse can be approximated which will excite all the eigen modes of the photoacoustic cell which can similarly be analysed.

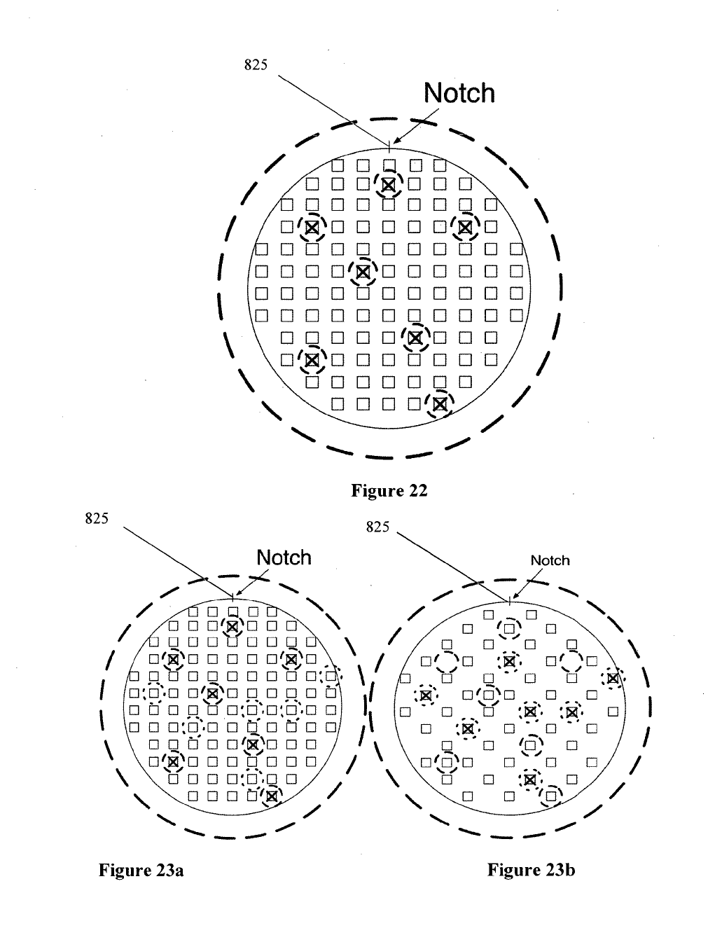

Referring now to FIGS. 21 to 23, an alternative pre-test mode is described. Due to time constraints it is in general impractical to measure an entire UUT as this would cause a bottleneck in the production line. In response to this, sampling protocols have been developed which reduce the requirement to test the entire wafer. These enable a small number of strategically placed measurements to stand in for blanket measurement, with an associated confidence level. Thus only part of the UUT is actually tested. In any industrial process, there is an inherent variation across the wafer. These variations are in general well understood in the art and this understanding is supported by statistical data. A priori information on the areas of interest is therefore critical in positioning the measurement cells of the photoacoustic metrology tool 800 for a given process. The tool may comprise one or more measurement cells which are strategically located with respect to the points of interest on the UUT. A critical aspect in the registration of measurement cells with the points of interest is the alignment of the unit under test 102. For a given application, the controller 802 may be programmed with data indicating the regions of interest on the UUT 102 which give a good representation of the variation across the wafer, or which are the most likely to be effected by the defect in question. FIG. 21 depicts an example of a seven point sampling pattern that the controller 802 may use in order to determine which areas of the UUT to apply photoacoustic analysis. Once this is determined, a photoacoustic sensor head is designed with the measurement cells positioned in registration with these sample points. FIG. 22 shows the measurement cells in registration with these measurement positions. The number of sensor heads available on a tool 800 may not be sufficient to measure all areas of interest in a single operation. In this scenario it is desirable to be able move the sample relative to the measurement cell.

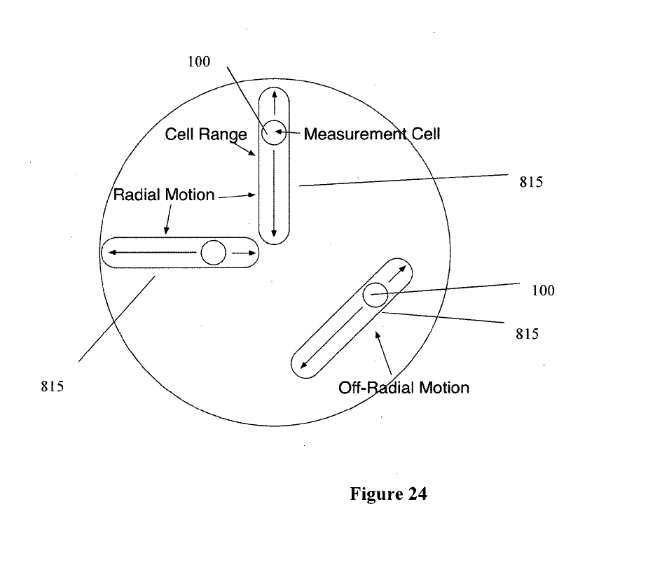

In a processing fab, a single tool 800 may be required to monitor multiple processes sequentially. As the different processes are likely to have different UUT layouts, the positions of interest in each process will likely vary. In order to add versatility to the tool 800, measurement cells can be placed in positions on the sensor head appropriate to each of the processes. Where necessary, certain measurement cells can be switched on/off depending on the process being investigated. FIG. 23 shows two experimental configurations for a single measurement head. Each configuration relates to a specific process and in each case the appropriate points of interest are marked with “X”. In FIG. 23A the active cells are marked with dashed lines whereas those marked with dotted lines are dormant for this sample configuration. The situation is reversed in FIG. 23B. In order to give maximum flexibility over the positioning of multiple measurement cells they should be movable relative to one another. The exemplary arrangement of FIG. 24 includes rails 815 along which the measurement cells of the tool are slideable to desired locations.

The photoacoustic metrology tool 800 in the pre-test mode may include a pre-alignment step such that the wafer arrives at the tool aligned to within a predetermined range, for example, +/−300 um. For some applications, such as TSV analysis, this alignment may suffice as the TSV fields are orders of magnitude larger that this and measurement methodologies can be devised to accommodate discrepancies in the positioning of the wafer. Other applications, e.g. bevel edge defects, may not be so forgiving however and may require additional alignment capabilities at the wafer level. The control circuit 801 may include a detection circuit 820 configured to detect a reference point on the wafer under test in order to facilitate aligning the wafer to the measurement cell. In the exemplary arrangement, the detection circuit 820 comprises a photo-diode which forms a photo detector which in combination with the light source 112 is operable for edge and notch detection. In this detection arrangement, the light source 112 is directed into the photo detector; the wafer is then moved between the two until the photo-diode signal reaches some predefined value (usually half its open value) and the edge is determined to be detected.

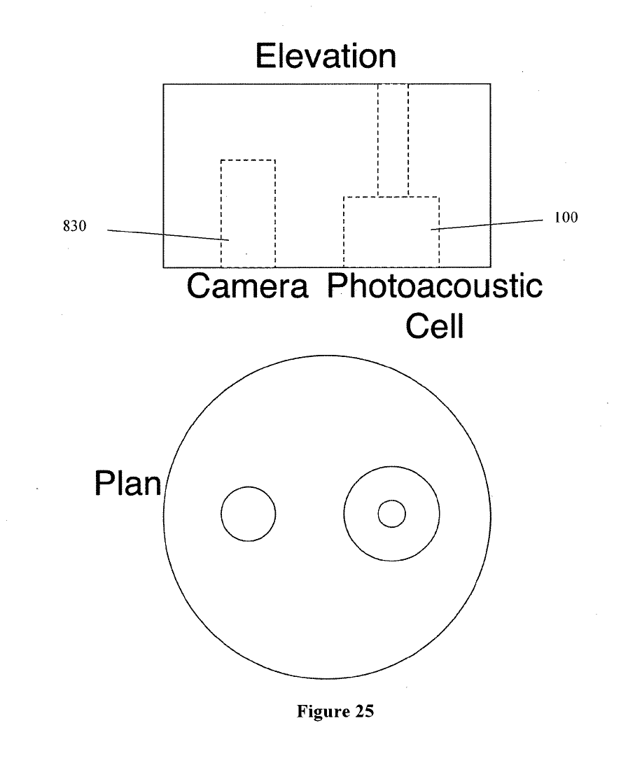

Alternatively, the tool 800 may be operable to align to the wafer edge or to fiducials on the wafer surface, a high resolution camera 830 can provide a solution. Placing a camera 830 within, or along side, the photoacoustic cell, as shown in FIG. 25, allows for the detection of fiducials, sample edge and/or notch in the immediate vicinity of the measurement cell 100. Using a known offset, the measurement cell 100 can then be positioned correctly. Under some circumstances an overview photoacoustic scan can be suitable for alignment. If there are known features on the sample a low/high resolution scan may be run to detect them, and using this information the local geometry of the sample can be determined, mapped and used to position follow up scans.

Referring now to FIGS. 26 to 28, bevel edge defects are becoming increasingly problematic in the semiconductor industry as wafer sizes increase, leading to reduced structural stability and increased perimeter occupancy. Bevel edge defects usually manifest themselves as slip bands—planes in the regular crystalline structure which have slipped relative to each other causing an inconsistency in the stacking structure—or micro-cracks. These defects are prone to expansion at high anneal temperatures and can at best be deleterious to edge yield (which is critical as wafer diameters move to 450 mm) and at worst cause the wafer to shatter in-process resulting not only in loss of the entire wafer batch but necessitating extensive down-time for the process tool in question.

A major source of bevel edge defects result from the grippers used to transport wafers around the fab and the process step critical to their expansion is thermal anneal. A major consideration in protecting against expansion of bevel edge defects is the uniformity of the temperature distribution within the anneal chamber. One application envisaged for the metrology photoacoustic tool 800 is using the tool to calibrate anneal chambers during their periodic preventative maintenance (PM).

Although in its normal direction, the slip band's extent can be as small as a single atomic plane its lateral extent provides the opportunity for photoacoustic detection. A slip band, if thermally activated will “glide” (expand) from one surface of the Si wafer to the other, i.e. will extend for 100's of microns. Although narrow, the slip band introduces an interface to which photoacoustic analysis is sensitive.

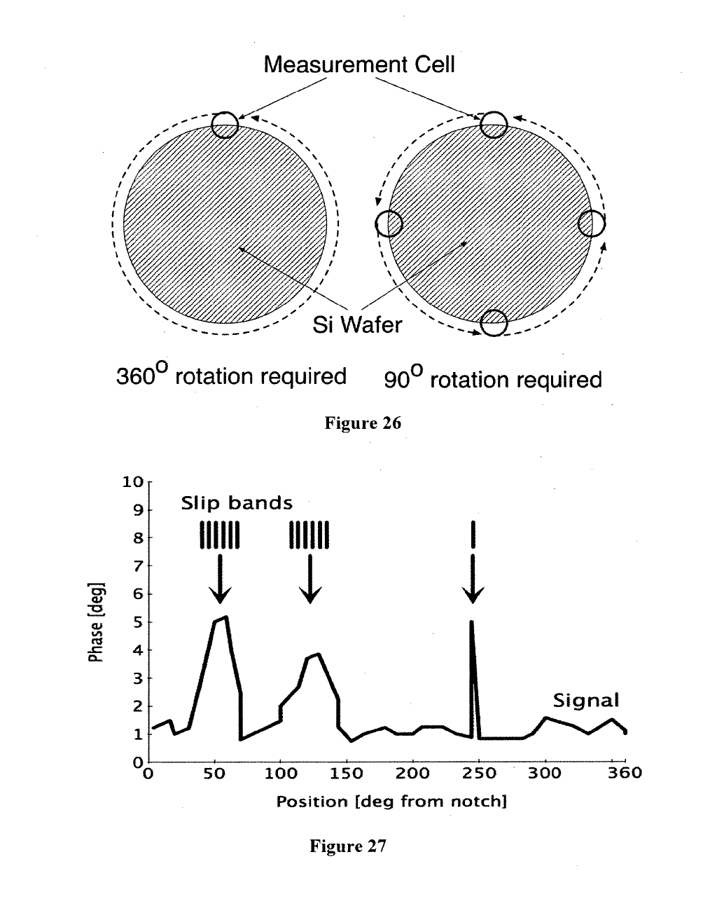

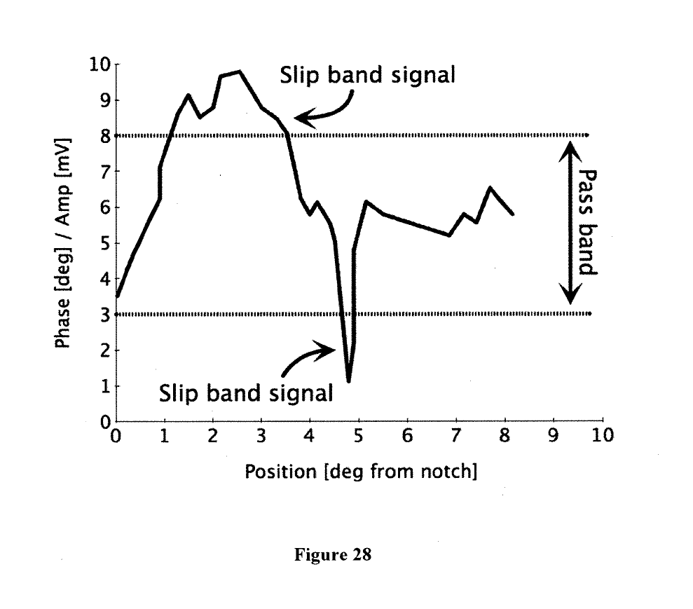

A major differentiator between photoacoustic microscopy and optical interferometry is that the photoacoustic metrology tool 800 may be used to investigate around the wafer notch, whereas current state of the art optical inspection tools have a ˜1-2 mm exclusion zone around the notch. The notch region can be especially problematic in terms of slip band generation. As their name implies, Bevel Edge Defects exist on the edge of a wafer. Given this fact, and the circular nature of the wafer, the most efficient method of measuring for these defects is to position the measurement point on or near the wafer edge and rotate the wafer. Given the proliferation of alignment steps in the semiconductor fabrication process and the standardised nature of the handling tool, it is likely that a wafer will be gripped repeatedly in the same locations. These locations may provide sections of the perimeter to target in a reduced range scan. Operating in rotation mode also allows for the possibility of introducing multiple heads located around the wafer perimeter, thereby reducing the total rotary distance required to achieve full wafer edge coverage as demonstrated in FIG. 26 or allows parallel measurement of key regions. FIG. 27 shows an example of data collected on a sample containing slip bands. The phase signal shows sensitivity to the slip bands, which is consistent with interface detection. One possible method of automatic detection of slip bands/micro-cracks would be to set up a pass band criterion, and any signals (possibly processed) which fall outside of this pass-band are deemed to be out of specification and possibly represent the presence of a defect, as demonstrated in FIG. 28. In an exemplary arrangement, the UUT was centred on its axis of rotation. The measurement head was aligned to the wafer edge and then stepped in from the edge by ˜300 microns. The wafer was stepped through a 360 degree rotation. At each step the photoacoustic amplitude and phase was recorded. The signals were analysed and processed. Data was output in a graphical format.

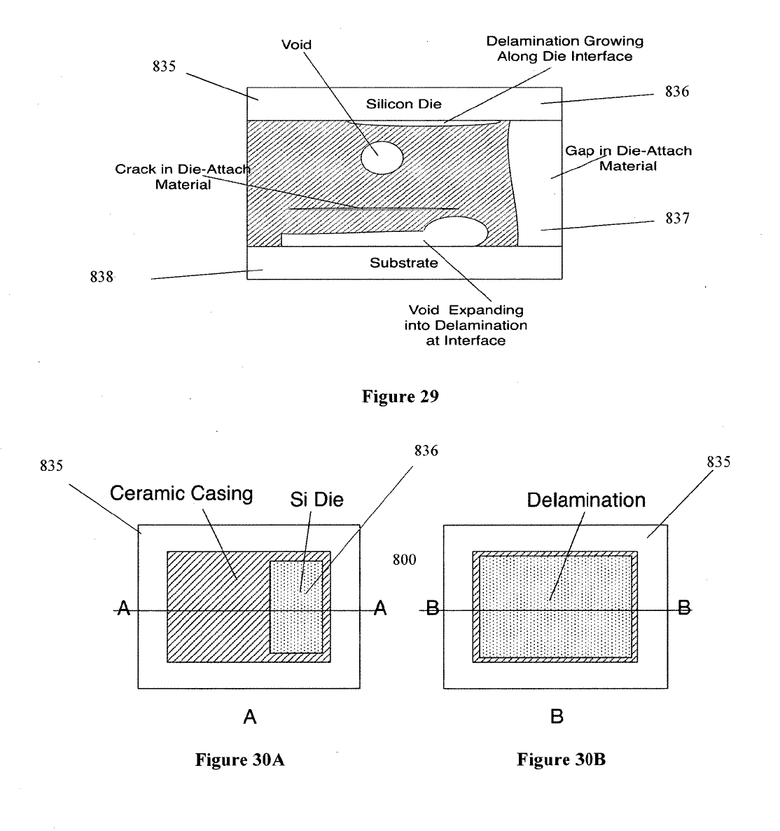

In both production wafer and fully packaged chips, interlayer delamination is a problem that may arise. Delamination is commonly initiated and/or expanded by thermal cycling and causes failures due to reduced structural integrity and/or connection isolation. The commonly encountered defects are shown in FIG. 29 in the context of a packaged chip 835. The packages chip 835 includes a silicon die 836 bonded to a substrate 838 with a die attach material 837. The defects may include for example, cracks in die-attach material, gaps in die attach material, delamination growing along a die interface between the silicon die 836 and the die attach material 837, voids etc. Wafers are often bonded directly through the application of pressure and heat thereby removing the necessity of the bond-attach material, however defects shown at the interfaces in FIG. 29 remain a concern.

The photoacoustic metrology tool 800 is particularly suited for identifying voiding and delamination in packaged chips 835 and at wafer level. The contrast in thermal properties between the air of the void and the surrounding materials; metals/ceramics/silicon in the case of the packaged chip and silicon/metal at the wafer scale allows defects to be identified using photoacoustic analysis. Due to this thermal contrast, the introduction of voids/delamination causes a demonstrable change in the, the photoacoustic signature relative to background structure.

Common practice in metrology is to measure relative to the “golden sample” or a known good sample. This methodology allows the analysis to mask out features unrelated to failure mechanisms. This technique may be carried out either in real time or off-line. In the real-time example, the two (or more) measurement cells would measure pre-aligned chips. These measurements could take the form of full X-Y maps or measurements at preselected locations with one of the measurement cells gathering data on a golden sample. The advantage to this methodology is that subtraction of the known good signal from that of the UUT signal not only removes unwanted detail, but also subtracts out the ambient noise given that the two signals were recorded in parallel.

Under certain circumstances the sample can be used as its own control. In this case, some a-priori information is required. FIGS. 30A and 30B shows an example of the photoacoustic amplitude across a packaged chip 835. It may be seen that a wide spread delamination event between the measurement surface and the silicon die 836 obscures the sub-surface detail. A possible method of monitoring for this type of event would be to measure a line across the chip (A-A or B-B) using the photoacoustic metrology tool 800 and analyse the variation of the amplitude and/or phase along the line. An alternative approach would be to analyse the variation in signal between targeted points on the UUT.

In general a bonded wafer will produce a uniform signal in areas of good adhesion, and non-uniformities represent delaminated regions. Therefore a method of analysing for variations from the norm is required. A full wafer map is the most comprehensive method of identifying delamination; however, there are trade-offs to be made around sample coverage and measurement time. A more practical and common practice is to measure a predetermined pattern which is developed through statistical analysis of the process. FIG. 31A shows a wafer 839 with delaminated regions 840 and a measurement pattern (marked with X's) designed to inspect the wafer 839 to a certain confidence level. FIG. 31B shows the photoacoustic amplitude which results from five repeated measurements at each point. The data of FIG. 31B may be analysed using standard statistical methods e.g. analysis of variance (ANOVA) or similar to detect the presence of outlier signals. This can be followed by analysis methodologies such as Tukey-Kramer to identify which of the measurements is the outlier.

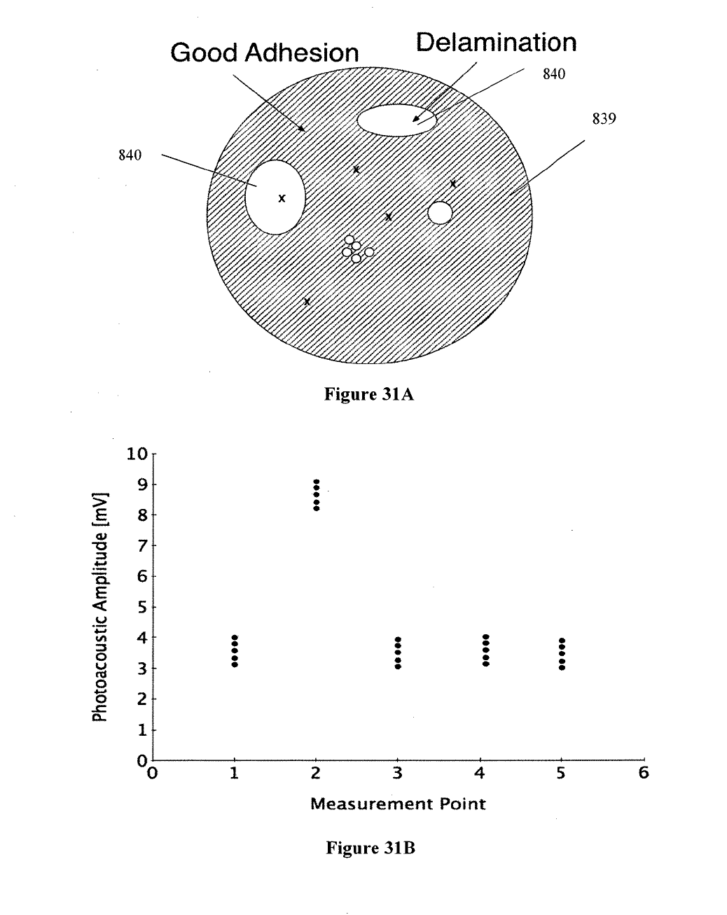

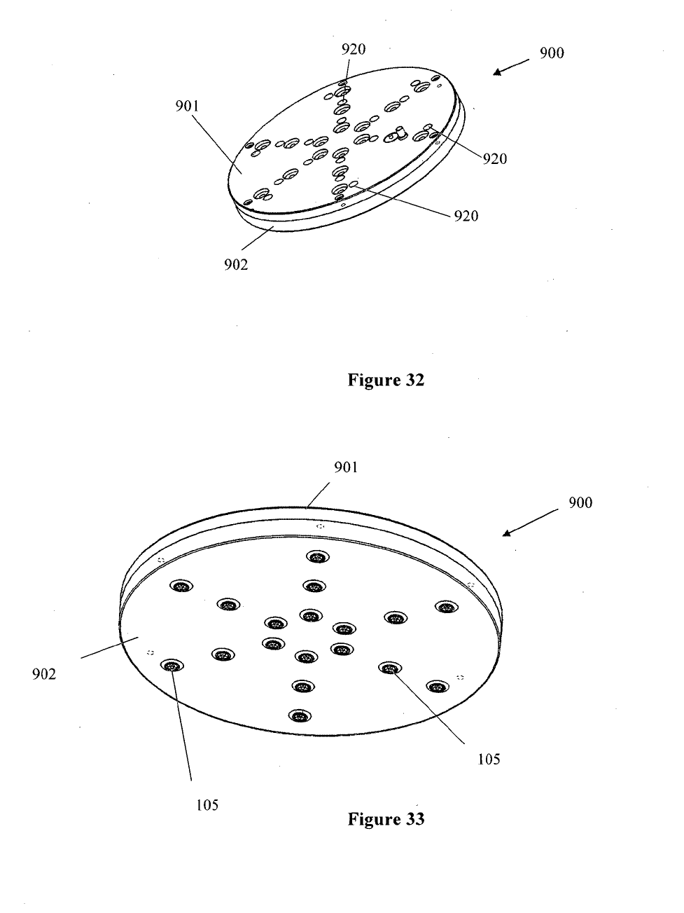

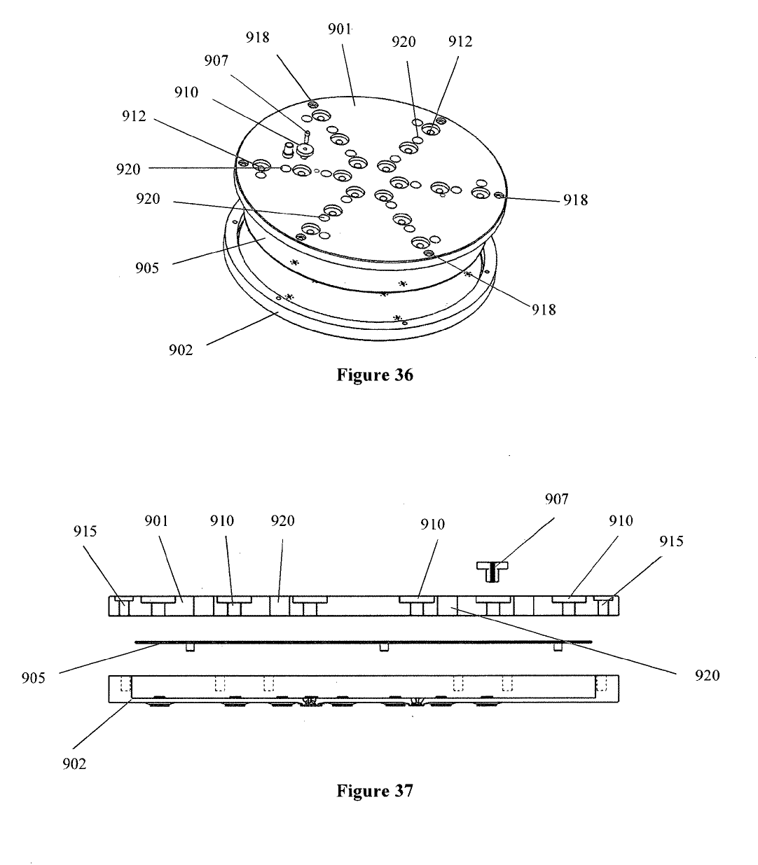

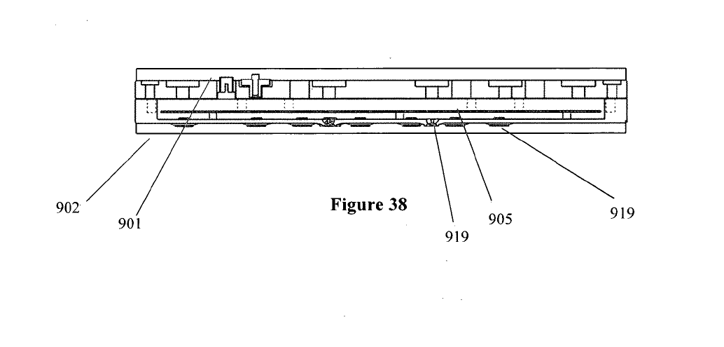

Referring now to FIGS. 32-38, there is provided a photoacoustic inspection device 900 arranged in a modular configuration. The device 900 may be used to provide a sensor head in the photoacoustic metrology tool 800, for example. Like components to those previously described are indicated with similar reference numerals. A top member 901 of the device 900 is configured to receive the inputs and outputs components of the sensor head such as a fibre optic which provides the light source 112. A bottom member 902 has acoustic trap volumes 105 formed therein. The top member 901 and the bottom member 902 together form a housing for accommodating a circuit board 905 therein. In the exemplary arrangement, the fibre optic is accommodated in a spigot 910 which is seated in complementary shaped socket 912 on the top member 901. The top member 901 and the bottom member 902 include complementary formations which inter-engage for securing the top and bottom members together. In the exemplary arrangement, plugs 915 extend through apertures 918 formed on the top and bottom members for securing the respective members together. Fastening elements 919 on the bottom member 902 are configured to operably engage corresponding plugs 915.

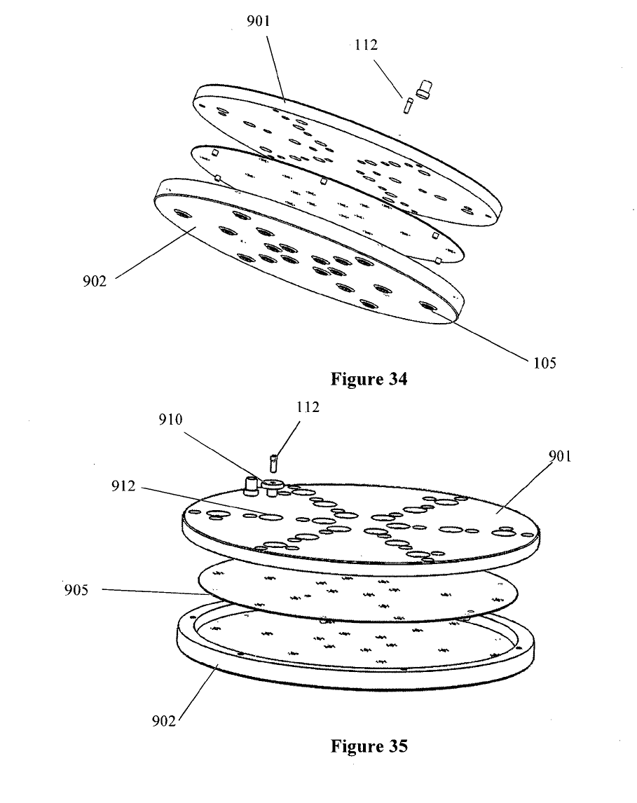

FIGS. 34-38 show exploded views of the modular arrangement of the device 900. The bottom member 902 houses the measurement cells (trap volumes 105) and sealing windows. Sandwiched between the bottom member 902 and the upper member 901 is the circuit board 905 onto which the microphone wires of the acoustic pickups 109 are operably coupled. The circuit board 905 may include the control circuit 801 for example. Connector outputs of the circuit board 905 are fed out holes 920 formed on the top member 902. The connector outputs may be Bayonet Neill-Concelman (BNC) or SMA, for example. The top member 901 of the assembly also houses the excitation optics. In this configuration, the excitation light from the light source 112 passes through apertures formed on the circuit board 905. Thus the electronic board 905 is perforated for accommodating light therethrough such that light passes from the light source 112 through the circuit board 905 for illuminating the trap volumes 105.

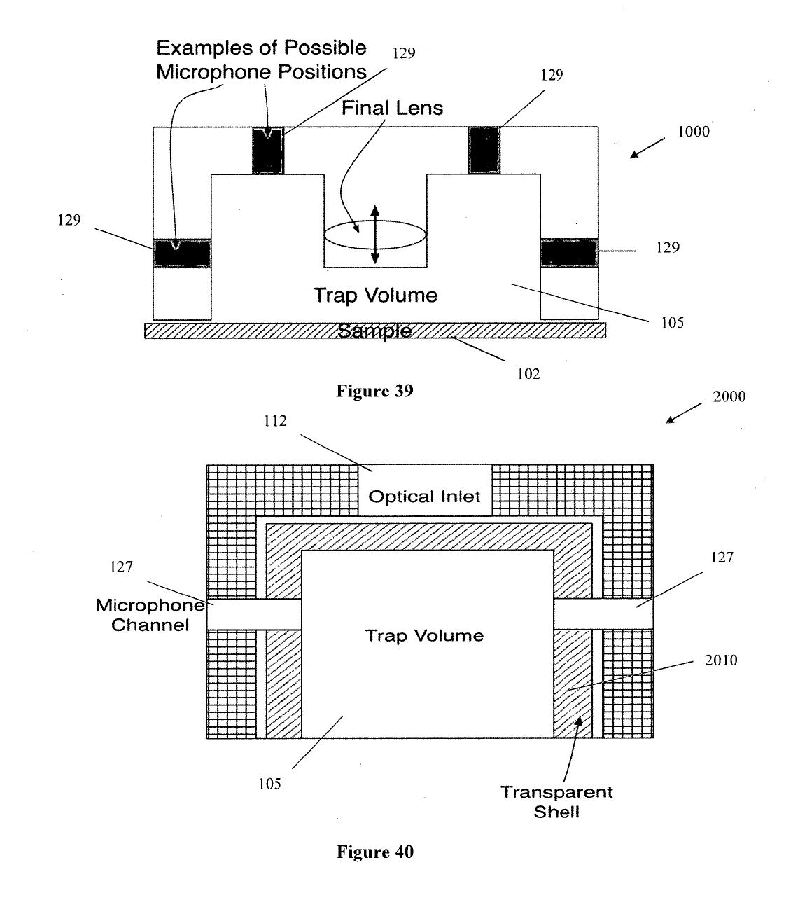

Referring now to FIG. 39 there is illustrated an exemplary photoacoustic inspection cell 1000. For convenience, similar components are indicated by like reference numerals as described in previous arrangements. The cell 1000 is shaped to resemble the letter ‘M’. The ‘M’ shape of the cell 1000 provides additional freedom in the sample-to-lens distance without requiring the use of a shallow cell thereby allowing additional freedom in the selection of microphone size. The specific shape may lend itself to certain resonances and/or acoustic properties. Variations of this may include an angled or curved interior surface.

Referring now to FIG. 40 there is illustrated an exemplary photoacoustic inspection cell 2000. For convenience, similar components are indicated by like reference numerals as indicated in previous arrangements. The cell 2000 is provided with a transparent lining 2010 which surrounds the acoustic trap volume. One of the main sources of coherent noise inherent to a photoacoustic measurement is absorption of reflected radiation on the cell walls. As this radiation originates in the modulated excitation, this signal from the cell walls is interpreted as a photoacoustic signal of interest. Lining the cell walls with a transparent shell separates the microphone inlet from the generally highly absorptive cell wall surface. Implementations of this may include an air filled/evacuated interstitial. As this lining acoustically defines the cell volume, it may be subject to any of the previous shape/size considerations. Alternative implementations may include the removal of the metal cell, leaving a purely transparent cell.

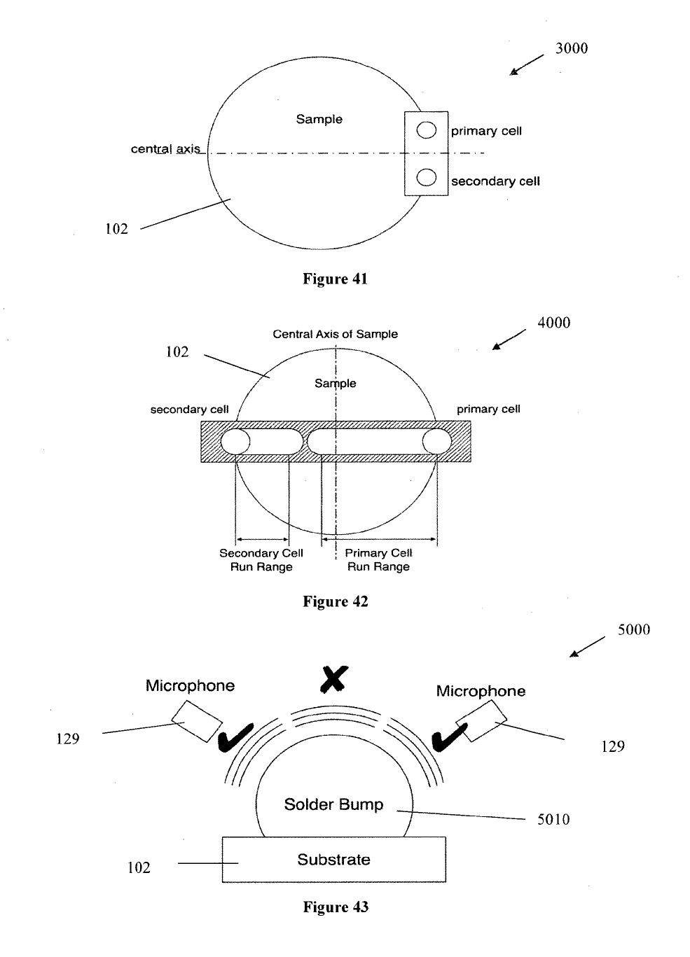

Referring now to FIG. 41 there is illustrated an exemplary photoacoustic inspection cell 3000. For convenience, similar components are indicated by like reference numerals as indicated in previous arrangements. In differential cell photoacoustics, a secondary cell measures the background acoustic signal. The secondary acoustic cell is not subjected to a pulsed laser source. If the secondary cell is exposed to the same acoustic environment as the primary measurement cell, the difference between the two is the photoacoustic signal of interest. If measuring a silicon wafer (or similar) one way in which the acoustic environments can be equalized is by separating the cells symmetrically about a central axis, as shown in FIG. 41. The problem with the configuration of FIG. 41 is that it leaves a region in the centre of the wafer inaccessible through r, theta motion. The photoacoustic inspection cell 4000 of FIG. 42 solves this problem. In the configuration of FIG. 42, the two cells travel on independent motors. At the outer edge of the sample 102, the secondary cell tracks any inward motion of the primary cell, thus mirroring its acoustic environment. Once the two cells have moved in sufficiently that the mouth of the cells are fully occluded by the sample, the acoustic environment should be relatively unchanging and the secondary cell's motion can stop. The additional range of the primary cell, provided by the limited range of the secondary cell allows this cell to access all regions of the sample 102 through the simple and standard r, theta addressing scheme.

Referring now to FIG. 43 there is illustrated an exemplary photoacoustic inspection cell 5000. For convenience, similar components are indicated by like reference numerals as indicated in previous arrangements. When measuring 3D structures on a sample surface, e.g. solder bumps 5010, the orientation and positioning of microphones 129 becomes critical. Directing the microphones 129 towards the source of the pressure wave increases the system's sensitivity to same. When measuring a flat surface, all regions are equivalent from the perspective of system sensitivity. When measuring sample surfaces with large curvatures, this is not the case as the photoacoustic signal will be preferentially projected normally to the surface. This give rise to amplification of signals originating in certain regions of the sample as shown in FIG. 43. These amplifications can be difficult to separate from signals of interest. One way to mitigate this effect is to equalise the sensitivity to pressure waves across area of the cell. This can be achieved by increasing the area of the microphone coverage. The ultimate solution would be to make the whole area of the cell wall sensitive to acoustic pressure, perhaps by coating with a piezo-electric material of sufficient sensitivity. Possible implementations of this would include a continuous pressure sensitive strip or a pressure sensitive “dome”.

Control of the acoustic environment within which the sample resides is an extremely important element of the noise reduction process. Sealing the sample in a close fitting cell which incorporates the measurement cell and all paraphernalia is an efficient means of controlling local acoustic environment. This efficiency is especially evident in a manufacturing environment where space is at a premium and acoustic noise can be severe. One implementation of this involves surrounding the sample and cell in an enclosure incorporating an evacuated region akin to double/triple (or more) glazing. Alternatively, one or more of these regions may be filled with a sound suppressing material.

Key to optimal performance in open cell photoacoustic measurements is the positioning of the cell and optics above the sample. The distance above the sample of these two elements can be critical. As the measurement conditions vary (e.g. measurement position on sample changes and/or height of sample changes due to wobble or other effects), changing the height of the cell and optics can compensate somewhat for any deleterious effects. The first arrangement in this context is a feedback system which automatically varies the position of the cell and/or the optics relative to the sample and optimises these distances. A second implementation includes a mechanism by which the distances previously mentioned can be observed in real time during an experiment. This allows the optimal sample-to-cell distance to be maintained via a feedback loop. Possible implementations of the distance observation include; ultrasonic transducer(s) on the perimeter of the cell, measurements of the light back reflected from the sample surface, and direct observation of the PA signal.

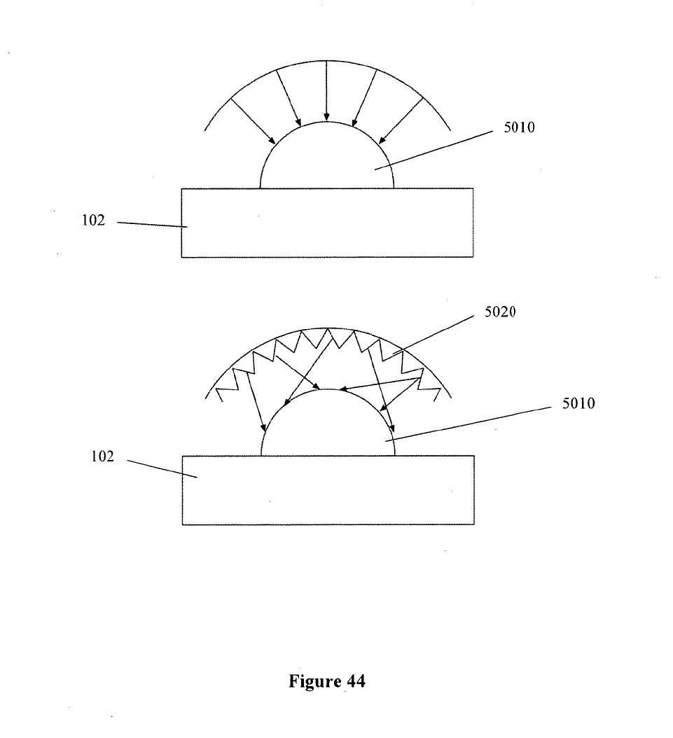

Referring now to FIG. 44, when measuring solder bumps 5010 the curvature of the bumps implies that the angle of incidence of the laser under normal conditions varies over bump 510. As the reflectivity of the surface is a function of the angle of incidence, this results in intra-bump intensity detail unrelated voiding/delamination in the bump. The plane-wave nature of the laser light causes this issue. Disrupting the plane-wave nature of the light may alleviate some of the reflectivity issues. One way of disrupting the plane-wave is to focus the light using a roughened concave mirror 5020, this may move evenly distribute the angle of incidence. However it is likely to reduce the intensity and increase the spot size of the light incident on the sample. A second possibility is to configure the optics in such a way that the focal point of the beam lies beneath the bump. With a short focal length lens, this could bathe the bump from all angles equally (nominally) and again alleviate the variability of the reflectivity across the bump 5010.

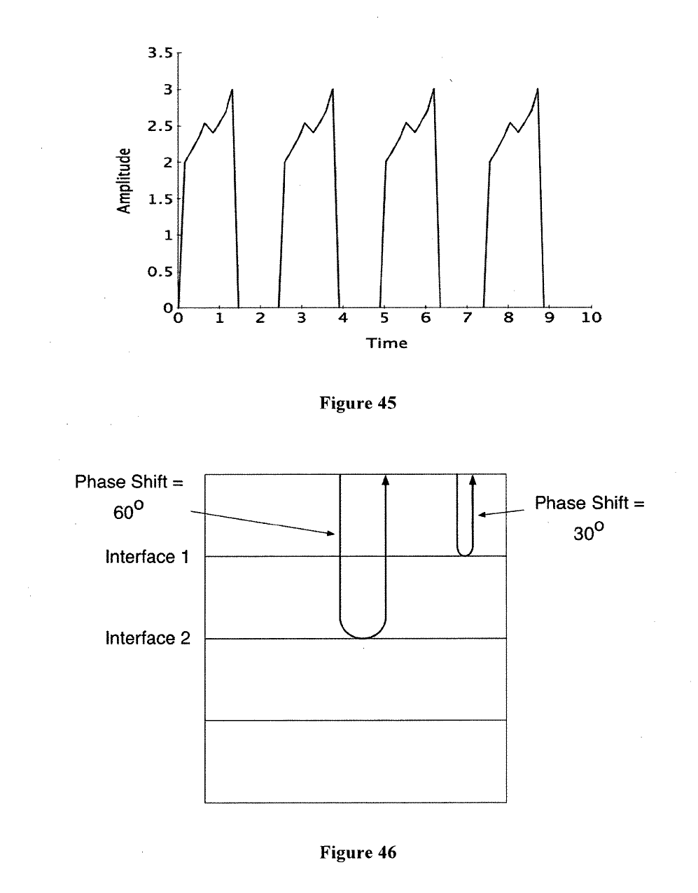

Referring now to FIGS. 45-49 which describes an analysis method which is also in accordance with the present teaching. The method is based on the fact that in a photoacoustic measurement, a portion of the detected signal is related to the heat reflected from subsurface interfaces. The phase of the signal detected is related to the thermal diffusion time within the sample, therefore the phase of a back-reflected signal is, to first order a function of the depth at which the reflecting interface occurs. By filtering the signals according to their phase, data reflecting from a specific interface can be isolated. The practice of phase “gating” (filtering) is used extensively in Scanning Acoustic Microscopy, in which short bursts of ultrasonic energy are fired at the sample and returning echoes are monitored. The application of phase gating to traditional photoacoustic analysis is cumbersome and of limited benefit as the use of a lock-in amplifier 899 results in an averaged signal over the wave, and single averaged values for amplitude and phase. The benefits of phase gating may only be recognised when one has access to the raw microphone data. To this end the implementation of useful phase gating requires the removal of the lock-in amplifier from the process flow, and the insertion of an analogue to digital converter (ADC) in its place.

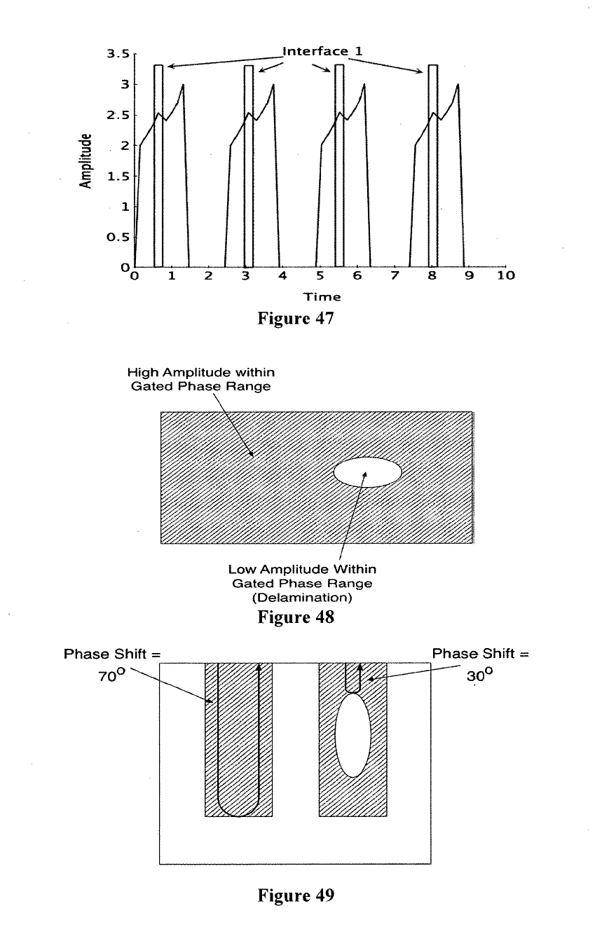

FIG. 45 shows an example of a dataset reconstructed from the raw microphone signals. The repeating representation of FIG. 45 is the periodic photoacoustic signal. In a multi-layered structure such as that shown in FIG. 46, signals reflecting from the various interfaces are all contained within each repeating representation of FIG. 45, they are separated temporally (in phase). The temporal extent of the structures therefore holds information on the depth of the reflecting interfaces as demonstrated in FIG. 47. If such a signal is analysed through a lock-in amplifier, this information is lost due to the averaging steps inherent to the operation of lock-in amplifiers. A solution to this problem is to use a time slicing approach the extract data originating at a particular interface may be determined. This time slicing method may be achieved by binning the amplitude data according to corresponding phase data, as shown in FIG. 47. Averaging of multiple periods can improve signal to noise levels.

If the measurement position is stepped over the sample, the data from a selected phase range can be extracted and stitched together to give a map (graphical representation) of the interface in question. In this case non-uniformities at, or prior to, the interface in question, will result in large variations in the amplitude extracted. This technique thus provides a very sensitive interface monitor, this is depicted in FIG. 48. The sensitivity of this method to non-uniformities at or above an interface makes it especially suited to detecting voids or similar prior to a structural interface, e.g. voids in TSVs. FIG. 49 shows the TSV structure (good and voided). In the case of the good TSV a baseline can be defined for the amplitude detected within a phase range associated with the bottom of the TSV (in the example ˜70°). The introduction of a TSV void will result in reduction of the amplitude within this phase range as it will block the head from reaching the base of the structure and will shift it into a different phase window. This measurement technique has the additional advantage of being able to estimate the depth at which the void occurs.

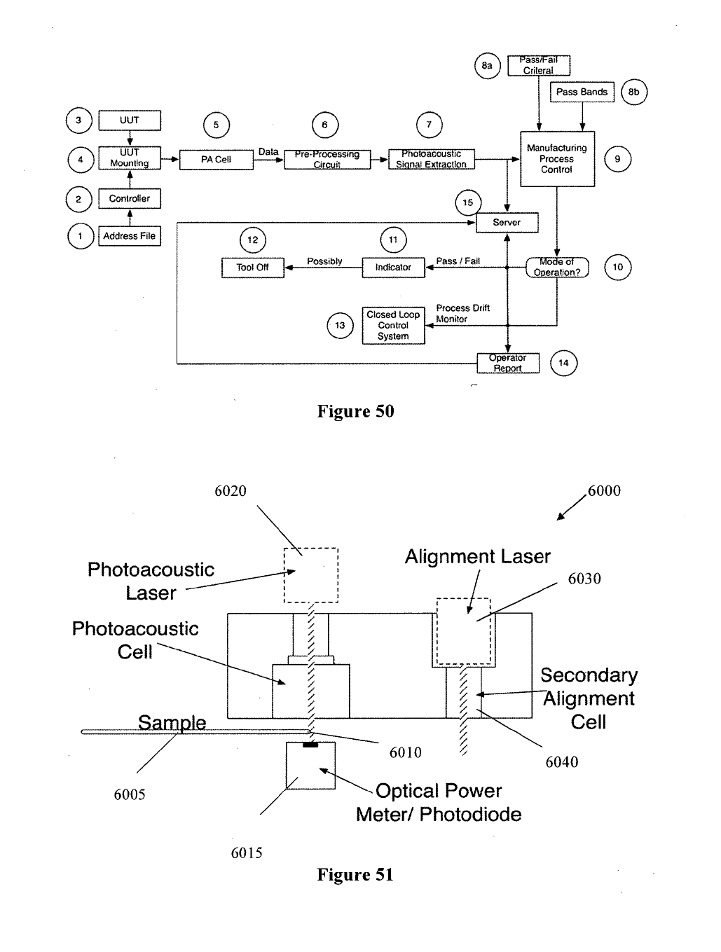

Referring now to FIG. 50 which illustrates an exemplary process that utilises the photoacoustic metrology tool of the present teaching. In step 1 a digital address file detailing points of interest on the UUT is presented to the controller. In step 2, the controller interprets the digital address file and instructs the motor to move to the UUT to positions corresponding to those specified in the digital address file. In the step 3, the UUT mounting incorporates motors for UUT translation/rotation and a mount for holding the UUT in place. For certain applications it may be necessary to hold the UUT in place securely, this is to ensure safety of the UUT, to ensure the translation of motion from the motors to the UUT and to retain alignment of the sample, whether it is pre-aligned before presentation to the tool or aligned within the tool. The size and shape of the sample will determine the most appropriate form for this handling mechanism. In the case of semiconductor wafers, a vacuum chuck may be used. For medical devices a gripper style mechanism may be more appropriate. In step 4, the UUT, in the exemplary arrangement has either been removed from the normal production line after some process step, or in the case of an in-line implementation, a sample which enters the photoacoustic system as part of the normal production flow. The sample may be presented to the tool pre-aligned (as is common in the semiconductor industry) or unaligned. In either case it may be necessary to align within the tool even if it is only a refinement. In step 5, the UUT is received by the photoacoustic metrology tool 800. As previously described the photoacoustic metrology tool 800 incorporates the optical excitation, the processing optics, the trap volume, the microphones and performs the actual measurements. Data from the photoacoustic metrology tool 800 is forwarded to a pre-processing circuit of step 6. The pre-processing circuit in step 6 implements any analogue pre-processing required prior to digitisation. This may include, but is not limited to, amplification and/or filtering. Data from the pre-processing circuit is relayed to a photoacoustic signal extraction module of step 7. The photoacoustic signal extraction module in step 7 processes the raw microphone data and digitises the raw data. The photoacoustic signal extraction module may use a digital lock-in amplification or digital signal processing. The former is a traditional methodology used to extract photoacoustic signal, the latter involves digitisation of the microphone data within an Analogue-to-Digital Converter (ADC) followed by a digital processing methodologies to extract the photoacoustic signal. Steps 8a and 8b represent alternative decision criteria that may be implemented during the process. Step 8a has a pass/fail monitor. Measurements will be carried out, the results of which will be compared against previously defined criteria and a pass/fail decision will be indicated on the monitor. In step 8b the measurement results indicate when a process begins to drift from nominal values. The process has not reached a failure point and the process parameters may be adjusted to keep the process within a defined specification. In step 9 pass/fail/parameter change decisions are made. In some cases this may be outside the metrology tool but in principle this could be an on-board microprocessor/Field Programmable Gate Array (FPGA), which in turn could also provide the controller of step 2. In any case, whether on-board or off-board, the system is in communication with this entity. In principle it could be a person watching the data. Step 10 determines the mode of operation, whether the system is operating in a simple Pass/Fail Mode or a more complex Closed Loop Control Mode. In step 11, in the Pass/Fail Mode, an operator indicator is provided for indicating to an operator whether a sample passes or fails. The indicator may take the form of a Red Light/Green Light or an on-screen indicator, possible also incorporating an alarm and/or a message to additional consoles. In step 12, if deemed appropriate, the Pass/Fail decision may also have the power to switch off the processing tool in question or a sub-set of it. Step 13 implements the closed loop control procedure as described in step 8b. In step 14, data relating to the failure or otherwise of a sample, possibly including, but limited to, a map of the sample indicating failure points can be generated at this stage in the process. In step 15, the data from step 14 may be pushed to a server for further analysis by process engineers or the like. The output of the system may be in a digital format readable by appropriate processing tools and familiar to engineers such as KLA Tencor's CLARITY.

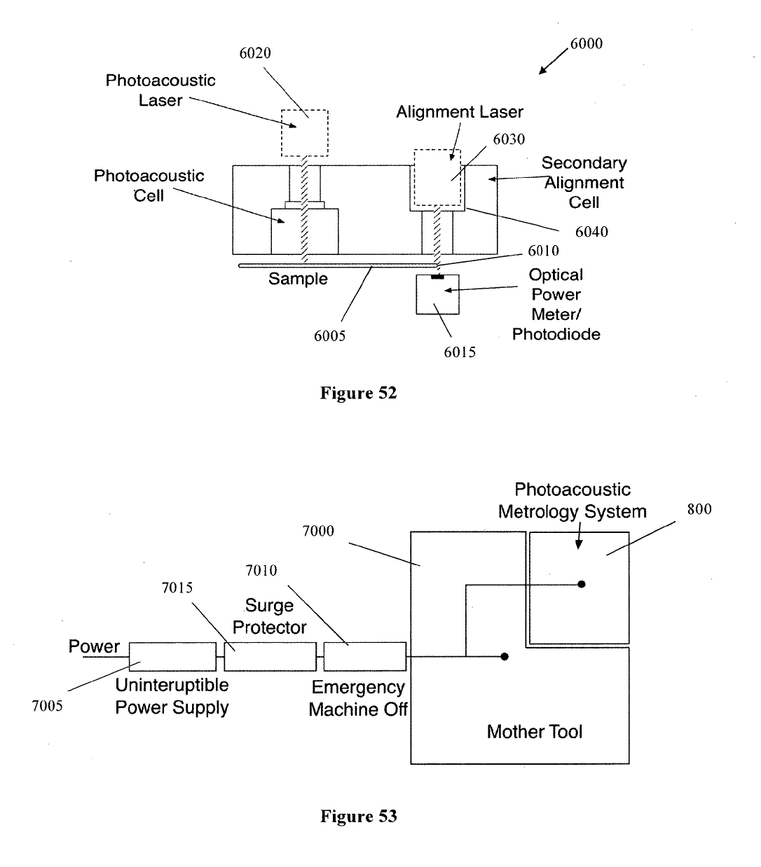

Referring now to FIGS. 51 and 52, there is illustrated an exemplary alignment arrangement 6000. The precise positioning of measurement points in a sample 6005 may be critical. Commonly, measurement positions are determined relative to fiducials on the sample 6005, most common among these is the sample edge 6010, and in the case of production semiconductor wafers, the notch. The photoacoustic metrology tool of the present teaching is configured to be able to locate the sample edge, or any other fiducial which results in a change in the optical power transmitted to a photodetector 6015. The principle of this arrangement is that an edge 6010 can be by monitoring the optical power reaching a photodetector 6015 as the sample 6005 cuts the beam. Once the optical power of the cut beam reaches some fraction of the unobstructed power, usually defined as half, but technically arbitrary, the edge 6010 of the sample may be detected.

In operation, either the photoacoustic laser 6020 or a secondary laser 6030 may be used for alignment of the sample 6005. FIG. 51 shows the first instance, in which the photoacoustic laser 6020 is used to detect the edge 6010. In this instance, the secondary alignment cell 6040 and laser 6030 are not required. However, the optimal optical configuration of alignment may not coincide with that of measurement. For alignment, a collimated beam is desired to make the alignment process robust against variations in the z position of the sample, some measurement conditions may require a focused beam. A somewhat related matter is that at very small spot sizes, very high resolution optical power meters are required. Additionally alignment requires only low optical power, whereas for photoacoustic measurements it may be desired to use high power. A high power optical power meter may be used if desired. These conflicting requirements for alignment and measurement points to a solution which splits the two processes, such a solution is shown in FIG. 52. This device isolates the two process. As the system has a monolithic design, it allows a fixed and constant offset between the alignment system and the measurement system. This allows one to align to the sample edge using the alignment cell 6040, and then by applying a fixed offset, move the measurement cell (and laser) into position. An additional option is to carry out a photoacoustic measurement around the edge of the sample 6005 to find same.

The photoacoustic metrology tool of the present teaching may include a safety interlock mechanism configured for switching off the laser when tripped which is used to optically excite the UUT. This is an important safety feature as ensures that operators are not accidentally exposed to the laser beam. The controller may include a processing means such as a circuit configured for extracting a photoacoustic signal from the electrical signal. In one arrangement, the processing means includes a microprocessor which is operable to generate digitised data representing the extracted photoacoustic signal. The microprocessor may be configured to analyse the extracted photoacoustic signal with respect to predetermined criteria. In one arrangement the processing means is configured to perform statistical analysis on the extracted photoacoustic signal. The processing means may be programmed to generate a report based on the extracted photoacoustic signal. In an exemplary arrangement, the report provides locations of points on the UUT that failed to meet predetermined criteria. The controller may be communication with a process control system in real-time. The process control system is operable to interpret the digitised data and control the process appropriately by varying parameters of the process. In one arrangement, the photoacoustic metrology tool 800 is provided as a standalone tool. In an alternative arrangement, the photoacoustic metrology tool 800 is integrated with a processing tool 7000 which is configured to perform a processing function on the UUT as illustrated in FIG. 53. The photoacoustic metrology tool 800 may be electrically powered via a power supply 7005 associated with the processing tool 7000. The power supply 7005 may have an associated emergency machine off switch 7010. In an exemplary arrangement, the power supply 7005 is associated with a power surge protector 7015. In the example, the power supply 7005 is an uninterruptable power supply (UPS) which provides emergency power to the processing tool 7000 during a power source failure. It will be appreciated by those skilled in the art that the digitised data may be relayed to a computing means for analysis. For example, the digitised data may be read by one or more processing tools 7000 during the production of the UUT. The controller may include an analog to digital converter for converting the electrical signal into a digital representation. The processing means may be operable to filter the extracted photoacoustic signal according to phase for identifying the depth of interface layers in the UUT. The processing means may be operable to generate a graphical representation of a layer interface using data from a selected phase range.

The photoacoustic metrology tool of the present disclosure may be operable coupled to local or remote client device. The client device may include a visual display unit on which pass/fail indicators outputted from the photoacoustic metrology tool are graphically displayed. Furthermore, test results from the photoacoustic metrology tool may be archived on a server for future retrieval. The photoacoustic inspection devices as described in the present application provide a flexible, low cost, non-destructive and highly sensitive metrology tool with ultra-fast imaging speed for in-line characterization of surface and sub-surface defects within advanced semiconductor devices. Such defects are typically located anywhere from a few to several hundred microns beneath the surface and are often covered by optically opaque multi-layer structures. It is difficult to detect such defects non-invasively using conventional inline metrology tools based on optical methods. The inspection devices of the present application facilitate non-contact investigation of large area semiconductor wafers and similar samples. Wafers may be tested non-destructively in real time without the need for additional gases. However, if required the devices may be housed in a chamber which contains gases other than air. These gases may include helium or argon or other suitable gases, which may be used to enhance the photoacoustic signals. The open cell design enables straightforward wafer insertion and positioning. It will be appreciated by those skilled in the art that the trap volume may be any desired shape. For example in FIG. 1 the trap volume is of cylindrical shape while in FIG. 12 the trap volume is of conical shape. It is desirable that the interior walls of the trap volume 105 have a curved surface for facilitating propagation of sound waves. Furthermore, it will be appreciated that the trap volume may be considered to be a blind channel in that one end is closed by the transparent window while the other end is open. One important advantage of the present photoacoustic inspection device is that the trap volume and the acoustic channels are provided on a single integral body (test member) which allows the trap volume and acoustic channels to be machined from a single piece of material which may be of metal or plastic. While the acoustic pick-ups/microphones are described as being located in the acoustic channels in the exemplary embodiments it is envisaged that they could instead be located in the trap volume. Alternatively, the acoustic pick-ups/microphones could be located in the trap volume and/or the acoustic channels.

It will be understood that what has been described herein are exemplary photoacustic metrology tools. While the present application has been described with reference to exemplary arrangements it will be understood that it is not intended to limit the teaching of the present application to such arrangements as modifications can be made without departing from the spirit and scope of the application. While in the exemplary embodiments the unit under test has been described as semiconductor wafers and the like, it is not intended to limit the UUT to such articles. It is envisaged that the UUTS could include for example, electronic products such as printed circuit boards (PCBs), LCDs, transistors, automotive parts, aeroplane parts, lids and labels on product packages, agricultural vegetation (seed corn, fruits, vegetables, or the like), and medical devices such as stents or the like.

Similarly the words comprises/comprising when used in the specification are used to specify the presence of stated features, integers, steps or components but do not preclude the presence or addition of one or more additional features, integers, steps, components or groups thereof.

1. A photoacoustic metrology tool comprising:
at least one light source for optically exciting a unit under test (UUT),
at least one volume for capturing acoustic energy emanating from the UUT as result of optical excitation thereof,
an acoustic pick-up for receiving the captured acoustic energy and generating a corresponding electrical signal, and
a control means being co-operable with the light source and the acoustic pickup for controlling photoacoustic analysis of the UUT.

2. (canceled)

3. A photoacoustic metrology tool as claimed in claim 1, wherein the control means is configured to read a digital file containing coordinates of points of interest on the UUT.

4. A photoacoustic metrology tool as claimed in claim 1, further comprising a processing means operable for extracting a photoacoustic signal from the electrical signal.

5. A photoacoustic metrology tool as claimed in claim 4, wherein the processing means is operable to generate digitised data representing the extracted photoacoustic signal.

6. (canceled)

7. (canceled)

8. A photoacoustic metrology tool as claimed in claim 4, wherein the processing means is configured to generate a report based on the extracted photoacoustic signal.

9. A photoacoustic metrology tool as claimed in claim 8, wherein the report provides locations of points on the UUT that failed to meet predetermined criteria.

10. A photoacoustic metrology tool as claimed in claim 1, wherein the control means is in communication with a process control system in real-time.

11. A photoacoustic metrology tool as claimed in claim 1, wherein the photoacoustic metrology tool is a standalone tool.

12. A photoacoustic metrology tool as claimed in claim 1, wherein the photoacoustic metrology tool is integrated with a processing tool which is configured to perform a processing function on the UUT.

13-15. (canceled)

16. A photoacoustic metrology tool as claimed in claim 5, wherein processing means is operable for relaying the digitised data to a computing means for analysis.

17. (canceled)

18. A photoacoustic metrology tool as claimed in claim 1, further comprising an indicating means for indicating whether the UUT complies with predetermined criteria.

19. A photoacoustic metrology tool as claimed in claim 1, wherein the control means comprises an analog to digital converter for converting the electrical signal into a digital representation.

20. A photoacoustic metrology tool as claimed in claim 4, wherein the processing means is operable to filter the extracted photoacoustic signal according to phase for identifying the depth of interface layers in the UUT.

21. A photoacoustic metrology tool as claimed in claim 20, wherein the processing means is operable generate a graphical representation of a layer interface using data from a selected phase range.

22. A photoacoustic metrology tool as claimed in claim 1, wherein the control means has a pre-test mode configured for identifying specific regions of interest on the UUT, and a test mode configured for performing photoacoustic analysis at the specific regions of interest identified during the pre-test mode, or at positions measured relative to the specific regions of interest.

23-25. (canceled)

26. A photoacoustic metrology tool as claimed in claim 22, wherein when the control means is in the pre-test mode it is operable to read location co-ordinates identifying the specific regions of interest on the UUT and, further wherein the control means is operable to register the specific regions of interest identified on the UUT with the light source based on the read location co-ordinates.

27-34. (canceled)

35. A photoacoustic metrology tool as claimed in claim 22, wherein when the control means is in the pre-test mode a digital image of the UUT is captured.

36. A photoacoustic metrology tool as claimed in claim 35, wherein the control means is operable to identify a reference point on the captured image.

37-52. (canceled)

53. A photoacoustic metrology tool as claimed in claim 22, wherein the volume has an access aperture and is formed on a member which includes a coupling means for operably coupling to a carrier mechanism, and further wherein a formation is provided adjacent the access aperture.

54-56. (canceled)

57. A photoacoustic metrology tool as claimed in claim 53, wherein the formation includes a protrusion or wherein the formation includes a recess or wherein the formation is annular or wherein the formation extends around the aperture or wherein the formation is configured for receiving a sealing member.

58-69. (canceled)

70. A photoacoustic metrology tool as claimed in claim 22, wherein the volume defines a region which is of a complimentary shape to the shape of the UUT for facilitating receiving the UUT therein.

71-78. (canceled)

79. A photoacoustic metrology tool as claimed in claim 57, wherein at least one secondary acoustic baffle is provided intermediate the volume and the control volume.

80. A photoacoustic metrology tool as claimed in claim 79, wherein the at least one secondary acoustic baffle includes one or more trenches.

81-97. (canceled)

98. A photoacoustic metrology tool as claimed in claim 79, wherein the at least one volume for trapping acoustic energy and the at least one light source are provided on a sensor head wherein the sensor head comprises a housing for accommodating a circuit board therein and wherein the circuit board is located intermediate the at least one light source and the at least one trap volume.

99-102. (canceled)

103. A photoacoustic metrology tool as claimed in claim 1, further comprising an alignment mechanism configured for aligning the UUT to a reference wherein the alignment mechanism comprises a laser.

104. (canceled)

105. A photoacoustic metrology tool as claimed in claim 103, wherein the alignment mechanism is configured for detecting an edge of the UUT.

106. A photoacoustic metrology tool as claimed in claim 105, wherein the alignment mechanism comprises a photo-detector.

107. A photoacoustic metrology tool as claimed in claim 98, wherein the circuit board is perforated for accommodating light from the at least one light source therethrough such that light from the at least one light source passes through the circuit board for illuminating the at least one trap volume.

108. (canceled)

109. A photoacoustic sensor head comprising:
at least one light source for optically exciting a unit under test (UUT),
at least one trap volume for capturing acoustic energy emanating from the UUT as result of optical excitation thereof, and
a circuit board having one or more acoustic pick-ups operably coupled thereto; a housing for accommodating the circuit board therein, wherein a plurality of light sources and a plurality of trap volumes are provided.

110-117. (canceled)
